(19) United States
(12) Patent Application Publication
(10) Pub. No.: US 2024/0362844 A1
(43) Pub. Date: Oct. 31, 2024

(54) FACIAL EXPRESSION PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventor: Kai LIU, Shenzhen (CN)

(21) Appl. No.: 18/766,440

(22) Filed: Jul. 8, 2024

Related U.S. Application Data
(63) Continuation of application No. PCT/CN2023/095567, filed on May 22, 2023.

(30) Foreign Application Priority Data
Aug. 4, 2022 (CN) 202210934106.3

(51) Int. Cl. G06T 13/40

(52) U.S. Cl. CPC G06T 13/40

(57) ABSTRACT

This application relates to a facial expression processing method performed by a computer device, the method including: determining a skeletal structure of a three-dimensional facial model of a target style; skinning the skeletal structure to generate a virtual object face; binding an action unit in a style expression template matching the target style to a one or more corresponding bones in the skeletal structure; associating at least one expression control with at least one action unit in the style expression template; in response to an adjustment operation on the at least one expression control, driving bones bound to the at least one action unit to move based on information of the at least one action unit associated with the expression control; and controlling the virtual object face to generate an expression conforming to the target style in accordance with the movement of the bones triggered by the adjustment operation.

### CROSS-REFERENCE TO RELATED APPLICATIONS

This application is a continuation application of PCT Patent Application No. PCT/CN2023/095567, entitled “FACIAL EXPRESSION PROCESSING METHOD AND APPARATUS, COMPUTER DEVICE, AND STORAGE MEDIUM” filed on May 22, 2023, which claims priority to Chinese Patent Application No. 202210934106.3, entitled “FACIAL EXPRESSION PROCESSING METHOD AND APPARATUS, COMPUTER DEVICE, AND STORAGE MEDIUM” filed with the China National Intellectual Property Administration on Aug. 4, 2022, both of which are incorporated by reference in their entirety.

### FIELD OF THE TECHNOLOGY

This application relates to the field of computer technologies, and in particular, to a facial expression processing method and apparatus, a computer device, and a storage medium.

### BACKGROUND OF THE DISCLOSURE

With the development of computer technologies, virtual objects are widely used in a plurality of fields, such as animations, movies, immersive interaction, and VR/AR. How to present vivid and delicate expressions on a virtual object face is particularly important. The virtual object face may be of a style. The style includes, but is not limited to, a cartoon style, a mobile game style, or an anime style.

In conventional technologies, an art designer generally processes an expression on a virtual object face of a style manually, to generate an expression conforming to the style, which consumes a lot of time and results in low efficiency in facial expression processing.

### SUMMARY

According to embodiments provided in this application, a facial expression processing method and apparatus, a computer device, a computer-readable storage medium, and a computer program product are provided.

According to one aspect, this application provides a facial expression processing method performed by a computer device and the method includes: determining a skeletal structure of a three-dimensional facial model of a target style; skinning the skeletal structure to generate a virtual object face; binding an action unit in a style expression template matching the target style to a one or more corresponding bones in the skeletal structure; associating at least one expression control with at least one action unit in the style expression template; in response to an adjustment operation on the at least one expression control, driving bones bound to the at least one action unit to move based on information of the at least one action unit associated with the expression control; and controlling the virtual object face to generate an expression conforming to the target style in accordance with the movement of the bones triggered by the adjustment operation.

According to another aspect, this application further provides a computer device. The computer device includes a memory and one or more processors. The memory has computer-readable instructions stored therein. The computer-readable instructions, when executed by the one or more processors, cause the computer device to implement operations of the foregoing facial expression processing method.

According to another aspect, this application further provides one or more non-transitory computer-readable storage media. The non-transitory computer-readable storage medium has computer-readable instructions stored thereon. The computer-readable instructions, when executed by one or more processors of a computer device, cause the computer device to implement operations of the foregoing facial expression processing method.

Details of one or more embodiments of this application are provided in the accompanying drawings and descriptions below. Other features, objectives, and advantages of this application become apparent from the specification, the accompanying drawings, and the claims.

### BRIEF DESCRIPTION OF THE DRAWINGS

To describe the technical solutions of embodiments of this application more clearly, the following briefly introduces the accompanying drawings required for describing embodiments. Apparently, the accompanying drawings in the following description show only some embodiments of this application, and a person of ordinary skill in the art may still derive other drawings from these accompanying drawings without creative efforts.

FIG. 1 is a diagram of an application environment of a facial expression processing method according to some embodiments.

FIG. 2 is a schematic flowchart of a facial expression processing method according to some embodiments.

FIG. 3 is a diagram of operations on an interface for model matching according to some embodiments.

FIG. 4 is a schematic diagram of action units according to some embodiments.

FIG. 5 is a schematic diagram of action units according to some embodiments.

FIG. 6 is a diagram of relationships between expressions and action units according to some embodiments.

FIG. 7 is a schematic diagram of facial muscles according to some embodiments.

FIG. 8 is a schematic diagram of action units according to some embodiments.

FIG. 9 is a schematic diagram of action units according to some embodiments.

FIG. 10 is a schematic diagram of expression parameters according to some embodiments.

FIG. 11 is a schematic diagram of action intensity according to some embodiments.

FIG. 12 is a schematic diagram of an expression control controlling a bone to move according to some embodiments.

FIG. 13 is a schematic diagram of expression controls according to some embodiments.

FIG. 14 is a schematic diagram of expression controls according to some embodiments.

FIG. 15 is a schematic diagram of expression controls according to some embodiments.

FIG. 16 is a schematic diagram of expression controls according to some embodiments.

FIG. 17 is a schematic diagram of a template determining window according to some embodiments.

FIG. 18 is a diagram of effect after rigging according to some embodiments.

FIG. 19 is a diagram of an interface for skinning according to some embodiments.

FIG. 20 is a diagram of an interface for generating a virtual object face according to some embodiments.

FIG. 21 is a schematic diagram of adjusting an expression on a virtual object face according to some embodiments.

FIG. 22 is a schematic diagram showing a virtual object face and expression controls according to some embodiments.

FIG. 23 is a schematic diagram of style expression templates meeting requirements of different expression intensity according to some embodiments.

FIG. 24 is a diagram of an interface for updating action units according to some embodiments.

FIG. 25 is a diagram of an interface for updating action units according to some embodiments.

FIG. 26 is a schematic diagram of freezing and activating an action unit according to some embodiments.

FIG. 27 is a diagram of an interface for exporting an expression template according to some embodiments.

FIG. 28 is a diagram of an interface for importing an expression template according to some embodiments.

FIG. 29 is a diagram of an interface for updating an expression template according to some embodiments.

FIG. 30 is a schematic flowchart of a facial expression processing method according to some embodiments.

FIG. 31 is a block diagram of a structure of a facial expression processing apparatus according to some embodiments.

FIG. 32 is a diagram of an internal structure of a computer device according to some embodiments.

FIG. 33 is a diagram of an internal structure of a computer device according to some embodiments.

### DESCRIPTION OF EMBODIMENTS

To make the objectives, technical solutions, and advantages of this application clearer, the following further describes this application in detail with reference to the accompanying drawings and embodiments. The specific embodiments described herein are merely used for explaining this application, and are not for limiting this application.

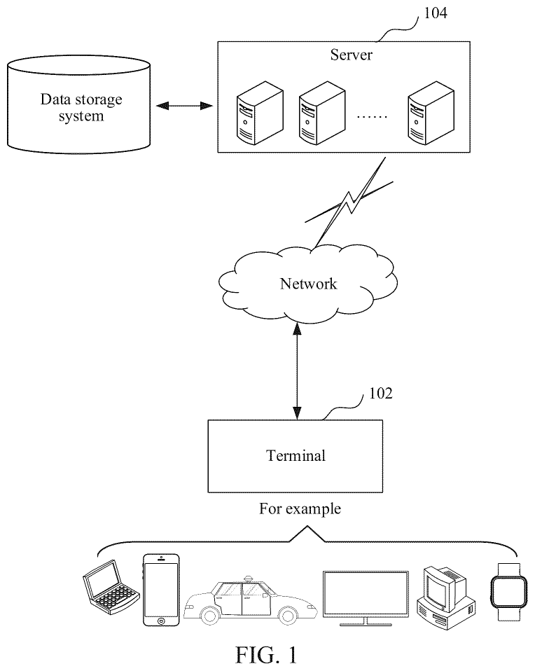

A facial expression processing method provided in an embodiment of this application may be applied to an application environment shown in FIG. 1. A terminal 102 communicates with a server 104 over a network. A data storage system may store data that the server 104 needs to process. The data storage system may be integrated on the server 104, or put on a cloud or another server.

Specifically, the terminal 102 may determine a skeletal structure of a three-dimensional facial model of a target style, determine a style expression template matching the target style, bind an action unit in the style expression template to a one or more corresponding bones in the skeletal structure, display a target expression control combination, associate an expression control in the target expression control combination with at least one action unit in the style expression template, skin the skeletal structure to generate a virtual object face, and drive, in response to an adjustment operation on at least one expression control, the bound bone to move based on information of the action unit associated with the expression control, to control the virtual object face to generate an expression conforming to the target style, so that the virtual object face with an expression can be generated. After the virtual object face with the expression is obtained, a virtual object with the expression may be exported, and the exported virtual object may be stored in a server. For example, the terminal 102 may generate, in response to an export operation on the virtual object face with the expression, a file that stores the virtual object face with the expression, and send the file to the server 104. The server 104 may store the file, and may also send the file to another device. The virtual object face is the face of the virtual object. A style includes, but is not limited to, at least one of a cartoon style or a mobile game style.

In some embodiments, art software may be installed on the terminal 102, and the facial expression processing solution provided in this application may be implemented by the terminal 102 using the art software. The art software may generate expressions suitable for corresponding styles for virtual objects of different styles. For example, the art software may include a customized art tool. The customized art tool is a result of independent research and development by the inventor. The customized art tool may be, for example, a plug-in developed in the art software. The art software includes, but is not limited to, Autodesk Maya or 3Dmax. The customized art tool may be configured to generate an expression suitable for a corresponding style for a virtual object of the style. For example, when that the virtual object is in a cartoon style, the art tool may be used to generate an expression conforming to the cartoon style for the virtual object. When that the virtual object is in a mobile game style, the art tool may be used to generate an expression conforming to the mobile game style for the virtual object.

The terminal 102 may be but is not limited to a variety of desktop computers, notebook computers, smartphones, tablets, Internet of Things devices, and portable wearable devices. The Internet of things devices may be smart speakers, smart televisions, smart air conditioners, smart on board devices, or the like. The portable wearable devices may be smart watches, smart bracelets, head-mounted devices, or the like. The server 104 may be implemented by using an independent server or a server cluster that includes a plurality of servers.

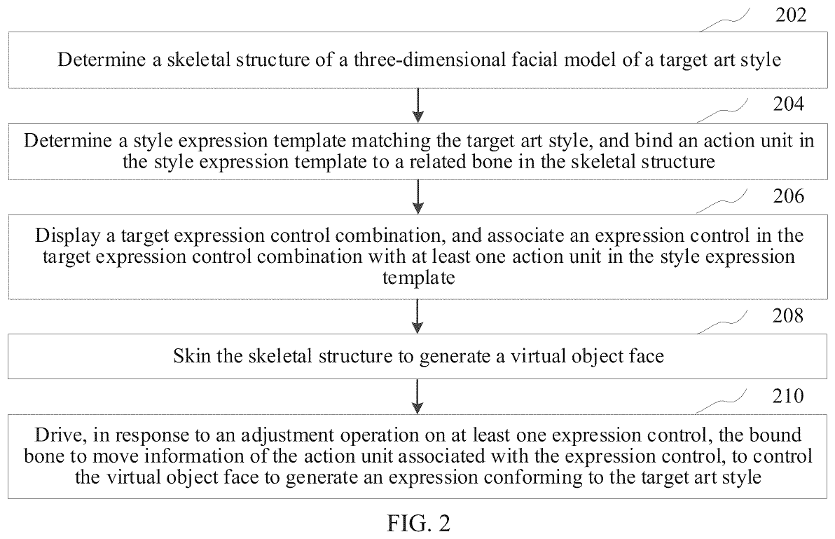

In some embodiments, as shown in FIG. 2, a facial expression processing method is provided. The method may be performed by a terminal or a server, or may be performed jointly by a terminal and a server. An example in which the method is applied to the terminal 102 in FIG. 1 is used for description. The method includes the following operations.

Operation 202: Determine a skeletal structure of a three-dimensional facial model of a target style.

A style is configured for representing an artistic feature of a virtual object. For example, the style includes, but is not limited to, at least one of a cartoon style or an anime style. Features of a virtual object in the cartoon style is quite different from features of a virtual object in the anime style. The target style may be any style.

The virtual object is an object in a virtual scene. The virtual scene refers to a digital scene drawn by a computer by using a digital communication technology. The virtual scene includes, but is not limited to, at least one of a two-dimensional virtual scene or a three-dimensional virtual scene. The virtual scene may be, for example, a scene in a game, a scene in virtual reality (VR), or a scene in an animation. The virtual object may be a virtual object with a face. For example, the virtual object may be any one of a virtual character, a virtual animal, or a virtual doll in the virtual scene.

The three-dimensional facial model is a three-dimensional mesh model (3D mesh) configured for representing a surface of a virtual object face. The virtual object face is the face of the virtual object. The three-dimensional mesh model is a polygonal mesh including a series of basic geometric figures, and is configured to simulate a surface of the virtual object. A basic geometric figure is the smallest shape that constitutes the three-dimensional mesh model. The basic geometric figure may be any one of a triangle or a quadrilateral. The basic geometric figure includes a plurality of vertices. For example, the triangle includes three vertices and the quadrilateral includes four vertices.

The skeletal structure of the three-dimensional facial model refers to a skeletal structure of the face of the virtual object. The skeletal structure of the three-dimensional facial model includes at least one of a nasal bone, a maxillary bone, a palatine bone, a lacrimal bone, an inferior turbinate, a vomer bone, or a mandibular bone. The skeletal structure of the three-dimensional facial model may be generated based on a standard skeletal structure. For example, bones in the standard skeletal structure may be bound to vertices in the three-dimensional facial model, and bones bound to the vertices in the three-dimensional facial model constitute the skeletal structure of the three-dimensional facial model. The standard skeletal structure refers to a skeletal structure bound to a standard three-dimensional facial model. The standard three-dimensional facial model is a pre-generated three-dimensional facial model, and vertices in the standard three-dimensional facial model are pre-bound to the bones in the standard skeletal structure. Each vertex in the standard three-dimensional facial model is bound to at least one bone in the standard skeletal structure. In embodiments of this application, the three-dimensional facial model of the target style may be referred to as a target three-dimensional facial model.

Specifically, the terminal may display the target three-dimensional facial model in response to an operation triggering display of the target three-dimensional facial model, and perform affine transformation on the standard three-dimensional facial model based on the target three-dimensional facial model when that a model matching operation is detected, to obtain a three-dimensional facial model undergone affine transformation. The affine transformation is configured for changing positions of the vertices in the standard three-dimensional facial model, so that the standard three-dimensional facial model is similar to the target three-dimensional facial model in terms of shape and position, so that a shape of the three-dimensional facial model undergone affine transformation is basically consistent with a shape of the target three-dimensional facial model. In addition, space enclosed by the three-dimensional facial model undergone affine transformation is basically the same as space enclosed by the target three-dimensional facial model, so that the three-dimensional facial model undergone affine transformation can represent a surface of a virtual object face. A quantity of vertices included in the target three-dimensional facial model is more than a quantity of vertices included in the three-dimensional facial model undergone affine transformation.

In some embodiments, the standard three-dimensional facial model has a plurality of key points, and the term “a plurality of” indicates at least two. The key points of the standard three-dimensional facial model are referred to as standard key points. A key point represents a position of a key part on a face. The key part includes, but is not limited to, at least one of eyebrows, eyes, a nose, a chin, or the like. Similarly, the target three-dimensional facial model has a plurality of key points, and the key points of the target three-dimensional facial model are referred to as target key points. The target key points may be in one-to-one correspondence with the standard key points. A target key point and a standard key point with a correspondence represent a position of the same key part. For example, if a target key point A is a point representing a position of a nose of the target three-dimensional facial model, and a standard key point B is a point representing a position of a nose of the standard three-dimensional facial model, then the target key point A corresponds to the standard key point B. The nose of the target three-dimensional facial model is a nose of the virtual object face corresponding to the target three-dimensional facial model. When that the terminal detects the model matching operation, the terminal may obtain the target key points of the target three-dimensional facial model, and obtain an affine transformation matrix based on coordinate transformation relationships between the target key points and the corresponding standard key points. The affine transformation matrix is configured for transforming coordinates of the standard key points to coordinates of the target key points corresponding to the standard key points, and may also be configured for transforming the coordinates of the target key points to the coordinates of the standard key points corresponding to the target key points. The model matching operation is configured for triggering the terminal to generate the three-dimensional facial model undergone affine transformation.

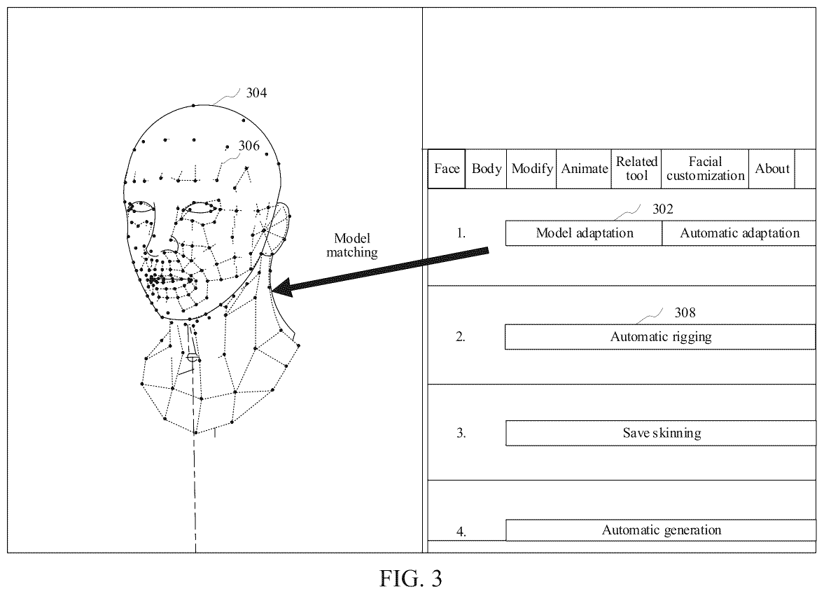

In some embodiments, when that the model matching operation is detected, the terminal performs the affine transformation on the standard three-dimensional facial model based on the target three-dimensional facial model, to obtain the three-dimensional facial model undergone affine transformation. During displaying the target three-dimensional facial model, the terminal may display the three-dimensional facial model undergone affine transformation. For example, the model matching operation is a click/tap operation on a control 302, namely, a “model adaptation” control, in FIG. 3. When that the click/tap operation on the “model adaptation” control is detected, the terminal generates a three-dimensional facial model undergone affine transformation, and displays the three-dimensional facial model undergone affine transformation corresponding to the target three-dimensional facial model. In FIG. 3, a part in solid line represents the target three-dimensional facial model, such as a part indicated by 304, and dotted lines and dots represent the three-dimensional facial model undergone affine transformation, such as a part indicated by 306.

In some embodiments, the vertices in the three-dimensional facial model undergone affine transformation are vertices obtained by transforming the coordinates of the vertices of the standard three-dimensional facial model. For example, if the standard three-dimensional facial model has 100 vertices, affine transformation are separately performed on the 100 vertices, in other words, coordinates of the 100 vertices are changed. The 100 vertices with coordinates changed are the vertices that constitute the three-dimensional facial model undergone affine transformation, and the vertices in the standard three-dimensional facial model are bound to the bones in the standard skeletal structure. Therefore, the terminal may move the bones in the standard skeletal structure and bind the moved bones to the vertices in the three-dimensional facial model undergone affine transformation, to obtain bones in a skeletal structure corresponding to the three-dimensional facial model undergone affine transformation. For example, vertex A1 in the standard three-dimensional facial model is bound to bone 1 in the standard skeletal structure, and vertex B1 in the three-dimensional facial model undergone affine transformation is a vertex obtained by performing affine transformation on, that is, moving, coordinates of vertex A1. Therefore, coordinates of bone 1 can be moved, and the moved bone 1 is determined as a bone bound to vertex B1. A method for moving a bone is determined based on movement of a bound vertex, so that a relative relationship between the bone and the vertex remains unchanged before and after movement.

In some embodiments, after generating the three-dimensional facial model undergone affine transformation, the terminal may determine, based on bones bound to the vertices in the three-dimensional facial model undergone affine transformation, bones bound to the vertices in the target three-dimensional facial model, to obtain a skeletal structure of the target three-dimensional facial model. The vertex in the target three-dimensional facial model is bound to at least one bone in the skeletal structure of the target three-dimensional facial model. Specifically, the vertices in the target three-dimensional facial model may be referred to as target vertices, and the vertices in the three-dimensional facial model undergone affine transformation may be referred to as affine vertices. For each target vertex in the target three-dimensional facial model, the terminal may determine an affine vertex closest to the target vertex from the three-dimensional facial model undergone affine transformation, and determine a bone bound to the affine vertex as a bone bound to the target vertex. Bones bound to the target vertices form the skeletal structure of the target three-dimensional facial model.

Operation 204: Determine a style expression template matching the target style, and bind an action unit in the style expression template to a one or more corresponding bones in the skeletal structure.

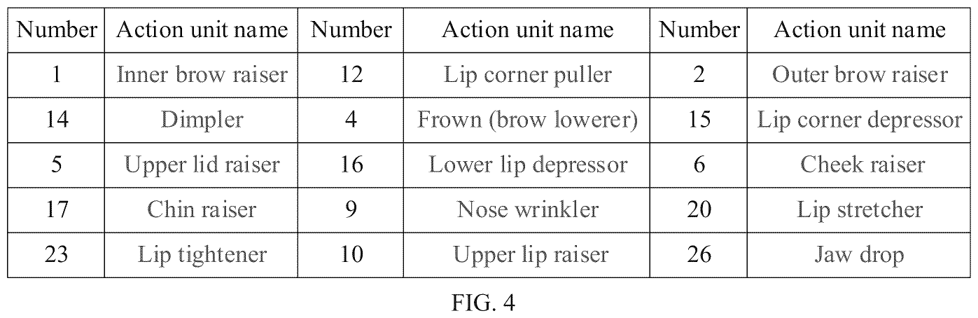

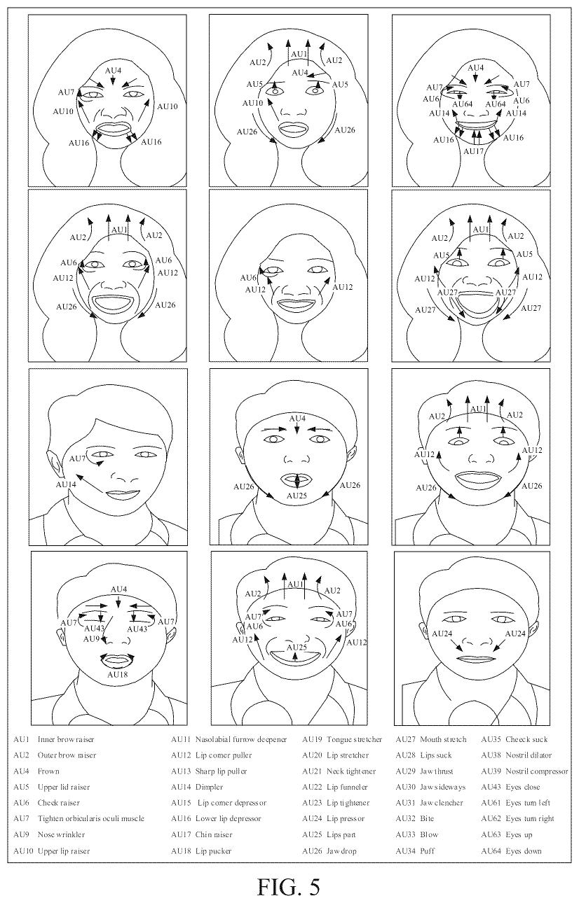

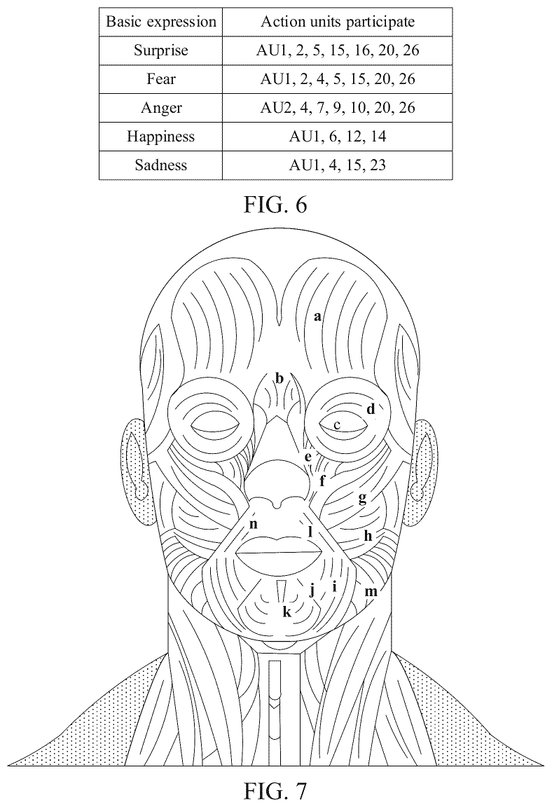

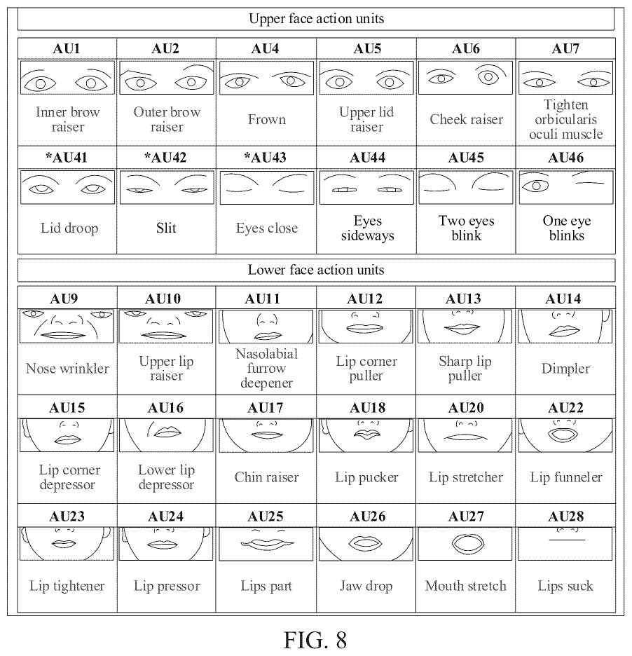

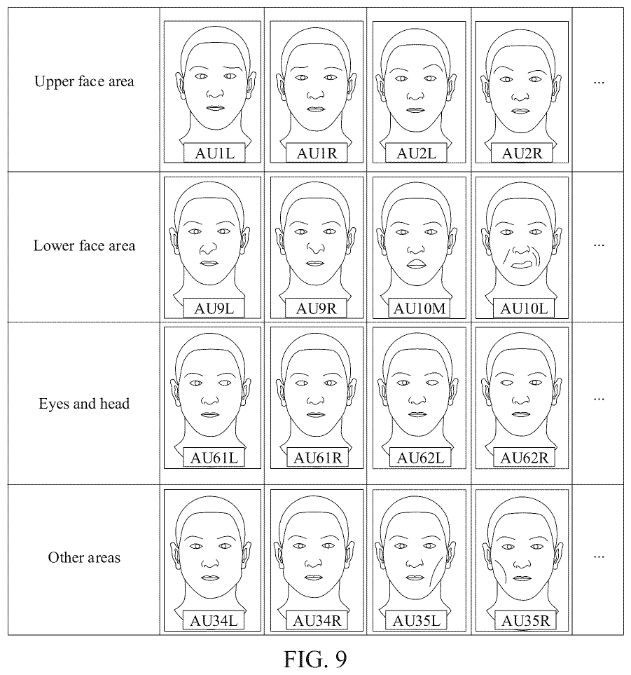

The style expression template is an expression template suitable for the style. Different styles match different style expression templates. The style expression template matching the style is pre-generated, and the style expression template matching the style may be modified. The style expression template includes a plurality of action units, and the term “a plurality of” indicates at least two, for example, may indicate 200. Each action unit (AU) may have a number and a name. Different action units have different numbers and different names. FIG. 4 and FIG. 5 show a plurality of action units. A number following AU in FIG. 5 is an AU number. For example, AU11 represents an AU numbered 11. A combination of a plurality of action units may represent an expression. In other words, the expression can be represented by the combination of the plurality of action units. FIG. 6 shows combinations of action units respectively corresponding to a plurality of expressions. For example, a combination of action units corresponding to “sad” includes AUs numbered 1, 4, 15, and 23. The action unit can measure facial muscles in a standardized manner, and the facial muscles may be, for example, muscles at positions of letters in FIG. 7. The face may be divided into an upper face and a lower face, and accordingly, the action unit may be divided into an upper face action unit and a lower face action unit. FIG. 8 shows some of the upper face action units and some the lower face action units. The AU in the foregoing example is a basic AU. Because precise of the basic AU is not high enough, the AU may be split or a new AU may be added. For example, the basic AU may be split into left and right parts, or left and middle parts, or may be split into middle and right parts, to obtain AUs with higher precise. Results of splitting a plurality of AUs are shown in FIG. 9. In FIG. 9, “R” is the abbreviation of right, representing a right part, “L” is the abbreviation of left, representing a left part, and “M” is the abbreviation of middle, representing a middle part. In FIG. 9, AU1 is split into left and right parts to obtain AU1L and AU1R, and AU10 is split into middle and left parts to obtain AU10M and AU10L. The action units in the style expression template may include action units obtained through splitting, to describe directions and strength of muscles more scientifically and comprehensively, thereby improving precise of an expression.

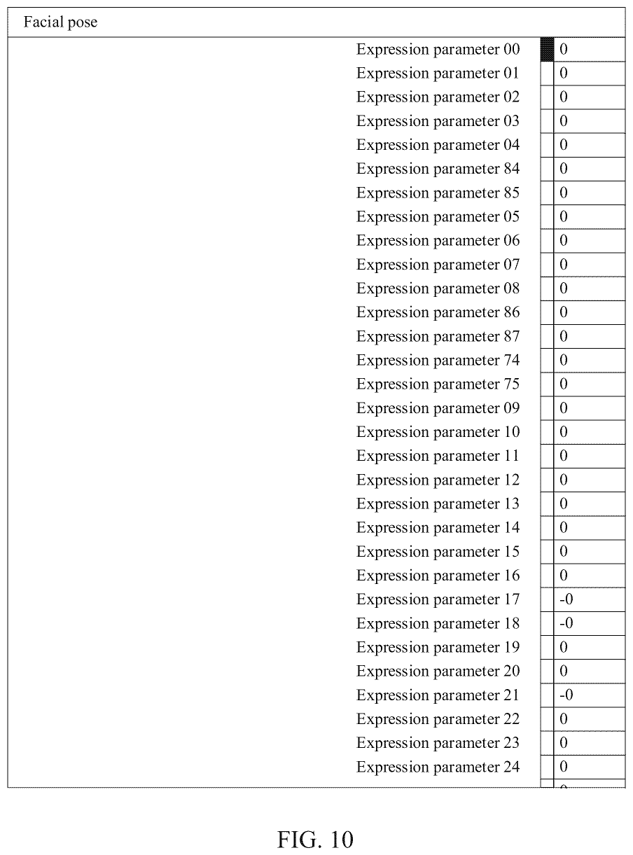

Each action unit has information. The information of each action unit includes action intensity and an action direction. The action intensity may also be referred to as movement intensity, and the action direction may also be referred to as a movement direction. The style expression template may include the information of the action unit, and the information of the action unit may be preset and may be modified. In the style expression template, an expression parameter may be used to represent an action unit. For example, AU1L refers to an action of inner brow raising of a left eyebrow. In the style expression template, information of the action unit can be described by using one single expression parameter. Different action units are represented by different expression parameters. The expression parameter may also be referred to as an animation parameter. FIG. 10 shows a plurality of expression parameters. Each expression parameter represents an action unit. For example, an expression parameter 00 represents an action unit. The action intensity may reflect different action degrees. Higher action intensity indicates a higher action degree. A value range of the action intensity may be preset, for example, may be 0% to 100%. In an example in which the action unit is an action unit controlling the opening of the mouth, FIG. 11 shows that A, B, C, D, and E respectively represent value ranges of different action intensity. A represents 0% to 20%, B represents 20% to 40%, C represents 40% to 65%, D represents 65% to 85%, and E represents 85% to 100%. It can be learned from the figure that higher action intensity indicates a higher degree of mouth opening. Binding may be understood as establishing a connection between an action unit and a bone, and a bound bone may be controlled to move through the action unit.

Specifically, after determining the style expression template, the terminal may bind an action unit in the style expression template to a bone in the skeletal structure of the target three-dimensional facial model. Bones that can be bound to respective action units are pre-specified in the style expression template. For example, it is specified that the action unit AU1L is bound to bone 1 and bone 2. When binding a bone to an action unit, the terminal may determine, from the skeletal structure of the target three-dimensional facial model, a bone that can be bound to the action unit, and bind the determined bone to the action unit. After binding, the terminal may control, based on the action unit, the bone bound to the action unit to move, to control the virtual object face to generate an expression conforming to the target style.

Operation 206: Display a target expression control combination, and associate an expression control in the target expression control combination with at least one action unit in the style expression template.

An expression control combination is a set of a plurality of expression controls, and an expression control is a control configured to control an expression. The target expression control combination is an expression control combination matching a target service scenario. The target service scenario is a service scenario that a target virtual object is in. The target three-dimensional facial model represents a face of the target virtual object. A service scenario includes, but is not limited to, at least one of a mobile game, a client game, or a digital human game. The complexity of different service scenarios varies. There may be a plurality of styles in a same service scenario, and accordingly, a process of determining the style expression template matching the target style may include: determining a style expression template matching a target style in the target service scenario. Matched expression control combinations for different service scenarios may be the same or different. The expression control combination matching the service scenario is preset. The operation “associate an expression control in the target expression control combination with at least one action unit in the style expression template” may be performed before displaying the target expression control combination, or may be performed after displaying the target expression control combination.

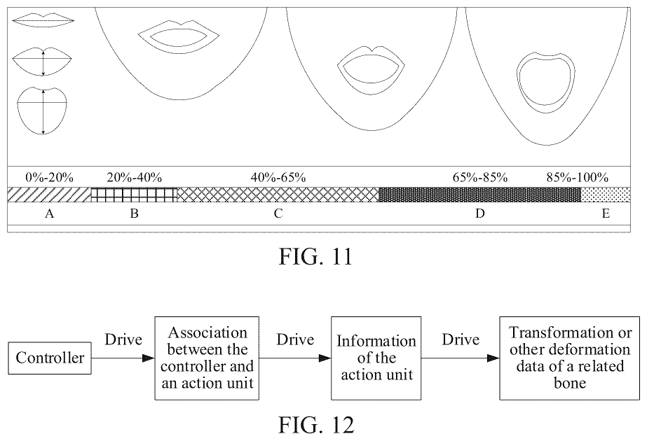

After the expression control is associated with the action unit, an operation on the expression control can trigger a bone bound to the action unit associated with the expression control to move. FIG. 12 shows a relationship between the expression control and a skeletal movement. A controller refers to an expression control. The expression control drives the bone to move based on the information of the action unit, to control an expression on the virtual object face. The expression control may also be referred to as the controller.

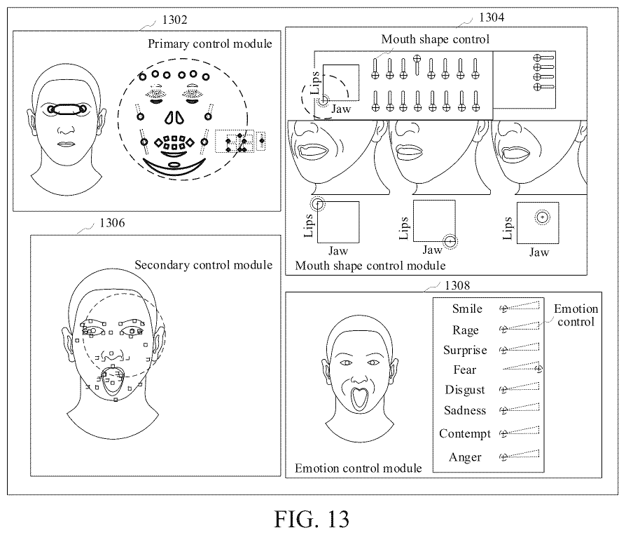

The expression control combination may include a plurality of types of expression controls, for example, may include a plurality of first expression controls, a plurality of second expression controls, and a plurality of shortcut expression controls, and the “a plurality of” indicates at least two. The plurality of first expression controls are configured to globally adjust the expression on the virtual object face. An expression pose may be quickly called out by the first expression control, and accordingly, the first expression control may also be referred to as a primary control. The second expression control is configured to adjust details of the expression on the virtual object face, and accordingly, the second expression control may also be referred to as a secondary control. The first expression control may be displayed at a position out of the virtual object face, and the second expression control may be displayed on the virtual object face. The shortcut expression control is matched with a specified expression, and the specified expression includes, but is not limited to, at least one of a specified emotion or a specified mouth shape. The shortcut expression control is configured to adjust the expression on the virtual object face, so that the specified expression matching the shortcut expression control is generated on the virtual object face. When that the specified expression matching the shortcut expression control is an emotion, the shortcut expression control may be referred to as an emotion control. When that the specified expression matching the shortcut expression control is a mouth shape, the shortcut expression control may be referred to as a mouth shape control. The emotion includes, but is not limited to, at least one of smile, rage, surprise, fear, disgust, sadness, contempt, or anger. The mouth shape includes, but is not limited to, AAA, AHH, and another mouth shape. FIG. 13 shows four types of emotion controls. Expression controls displayed in an area 1302 are primary controls, expression controls displayed in an area 1304 are mouth shape controls, controls displayed in an area 1306 are secondary controls, and controls displayed in an area 1308 are emotion controls, such as an emotion control corresponding to smile. The expression control combination includes primary controls, secondary controls, mouth shape controls, and emotion controls, which reflect hierarchical design of controls. The controls may be mixed in use to improve precise of an adjusted expression.

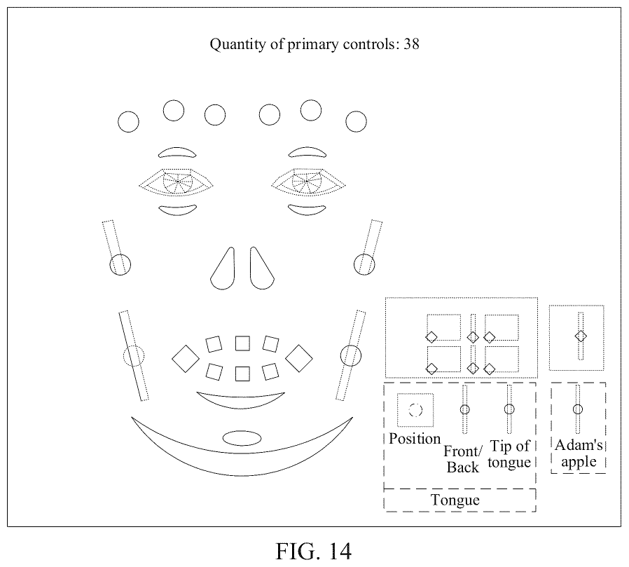

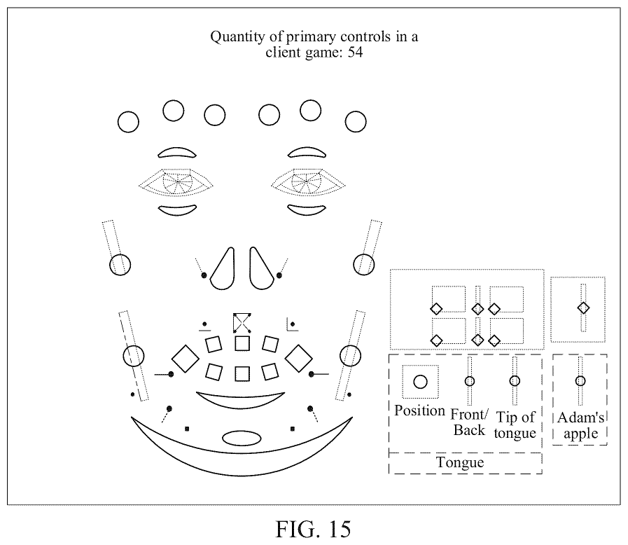

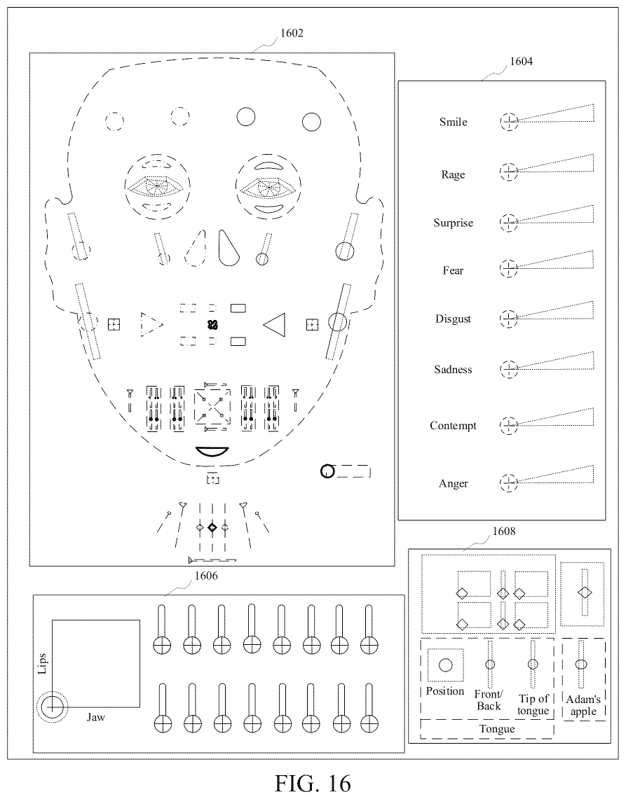

A quantity of the first expression controls may be determined based on scenario complexity of the target service scenario. For example, the quantity of the first expression controls is positively correlated with the scenario complexity of the target service scenario. A more complex target service scenario indicates a larger quantity of first expression controls. For example, complexity of the mobile game is lower than that of the client game, and complexity of the client game is lower than that of a digital human scenario, and accordingly, a quantity of primary controls in the mobile game is smaller than that of the client game, and a quantity of primary controls in the client game is smaller than that of the digital human scenario. For example, there are 38 primary controls in the mobile game, 54 primary controls in the client game, and 75 primary controls for a digital human character. FIG. 14 shows the primary controls of the mobile game, FIG. 15 shows the primary controls of the client game, and FIG. 16 shows various expression controls of the digital human character. Controls in an area 1602 and an area 1608 are primary controls, in an area 1604 are emotion controls, and in an area 1606 are mouth shape controls.

Specifically, the target three-dimensional facial model belongs to the target virtual object, and the target virtual object is a virtual object in the target service scenario. The terminal may display a style in each service scenario, including the target style in the target service scenario. When determining that the target style in the target service scenario is selected, the terminal determines the style expression template matching the target style and the target expression control combination matching the target service scenario. The terminal may associate the expression control in the target expression control combination with at least one action unit in the style expression template. For example, an association between the expression control and the action unit may be pre-stored in the terminal. For example, it is specified that an expression control 1 is associated with an action unit 1. The terminal may associate the expression control in the target expression control combination with at least one action unit in the style expression template based on the pre-stored association.

In some embodiments, the terminal may determine the style expression template matching the target style, bind the action unit in the style expression template to the one or more corresponding bones in the skeletal structure, determine the target expression control combination matching the target style, and display the target expression control combination matching the target style.

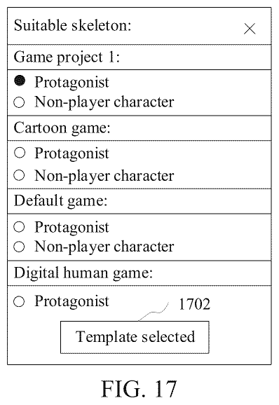

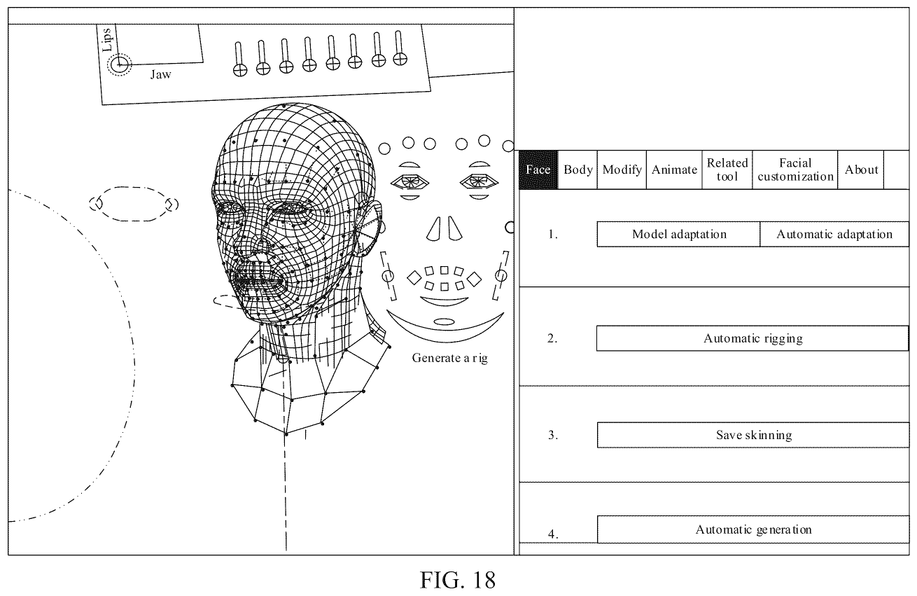

In some embodiments, the terminal displays a template determining window in response to a binding operation. The template determining window is configured for determining the style expression template matching the target style. The terminal obtains the style expression template matching the target style in response to a selection completion operation triggered in the template determining window. The selection completion operation is an operation indicating that selection of the style expression template matching the target style is completed. The terminal binds the action unit in the style expression template to the one or more corresponding bones in the skeletal structure, determines the target expression control combination matching the target style, and displays the target expression control combination matching the target style. The template determining window is configured for determining the style expression template matching the target style. The template determining window is, for example, a window in FIG. 17. The binding operation may be, for example, a click/tap operation on a control 308, namely, an “automatic rigging” control in FIG. 3. The selection completion operation may be, for example, a click/tap operation on a control 1702 in FIG. 17. Upon receipt of the click/tap operation on the control 308, the terminal displays the template determining window in FIG. 17. Upon receipt of the click/tap operation on the control 1702, the terminal displays FIG. 18. Expression controls are displayed in a left window of FIG. 18.

Operation 208: Skin the skeletal structure to generate a virtual object face.

The skinning is a process of binding vertices in a facial skin model to the bones in the skeletal structure. The facial skin model is a three-dimensional mesh model representing facial skin. The virtual object face is a result of the skinning. The facial skin model may be pre-generated.

Specifically, for each vertex in the facial skin model, the terminal may determine from the skeletal structure a bone closest to the vertex, and bind the bone to the vertex, so as to bind the vertices in the facial skin model to the bones in the skeletal structure, so that the skinning is implemented. After the skinning, the virtual object face is obtained.

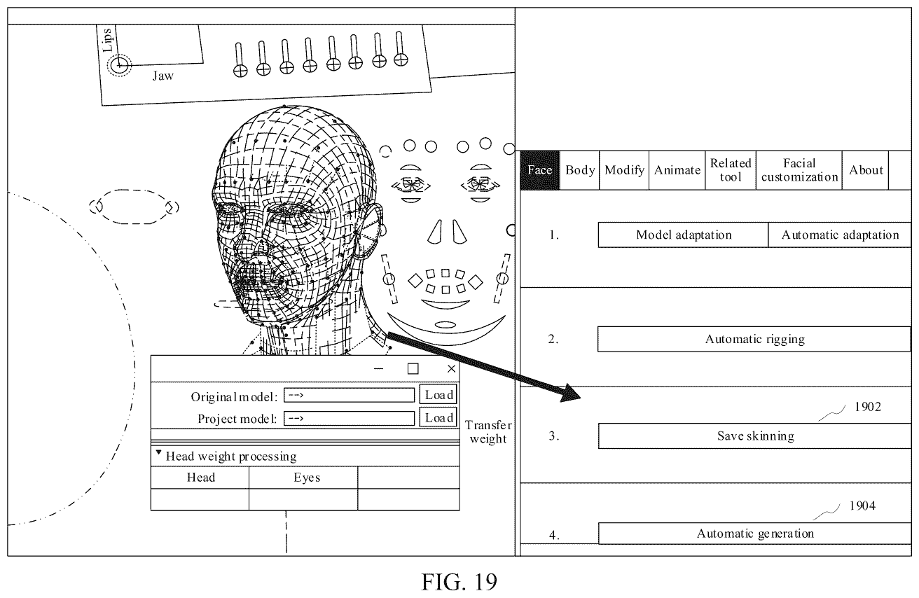

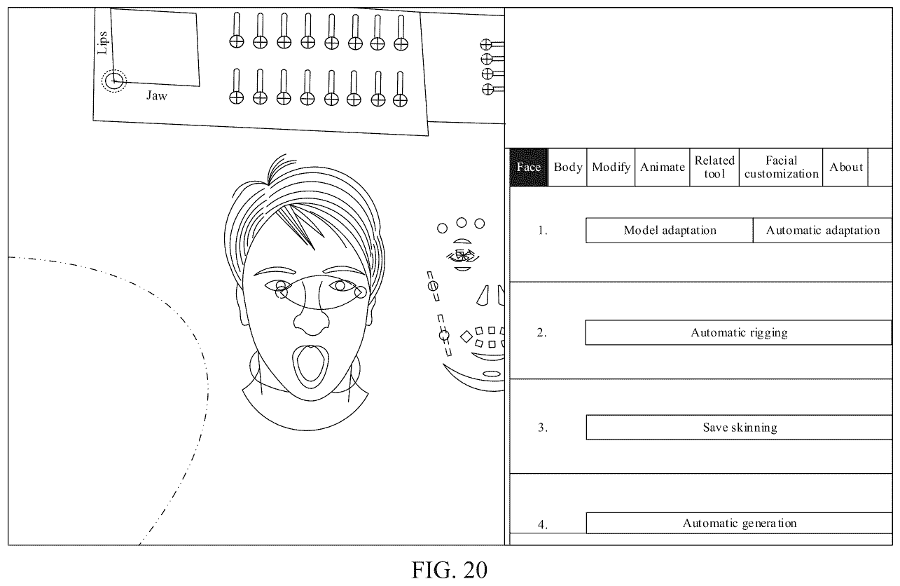

In some embodiments, the terminal may display a skinning control and a face generation control, bind a selected facial skin model to the skeletal structure in response to a trigger operation on the skinning control, and generate and display the virtual object face in response to the face generation control. Skin of the virtual object face is skin represented by the facial skin model bound to the skeletal structure. The skinning control is, for example, a control 1902, namely, a “save skinning” control in FIG. 19, and the face generation control is, for example, a control 1904, namely, an “auto generation” control in FIG. 19. Upon receipt of a click/tap operation on the control 1904, the terminal generates and displays a virtual object face, for example, generates and displays a virtual object face in FIG. 20. The generated virtual object face is an asset that may be controlled by an art designer. The virtual object face may be saved as an asset file. The terminal may provide a service for downloading the asset file. The virtual object face may be controlled by using the expression controls to change according to requirements of the art designer.

Operation 210: Drive, in response to an adjustment operation on at least one expression control, the bound bone to move based on information of the action unit associated with the expression control, to control the virtual object face to generate an expression conforming to the target style.

The adjustment operation on the expression control is configured for changing an attribute value of the expression control. Different attribute values of the expression control result in different degrees of adjustment on the expression. A greater attribute value indicates a higher degree of adjustment on the expression. For example, when that the expression control is an emotion control of surprise, a greater attribute value of the expression control indicates a higher degree of surprise. The expression control includes a control that may be in any form, including but not limited to a sliding control or a movable control. For example, the first expression control and the second expression control may be movable controls, and the mouth shape control and the emotion control may be sliding controls. An adjustment operation on the sliding control is a sliding operation on the control, and an adjustment operation on the movable control is a moving operation on the control.

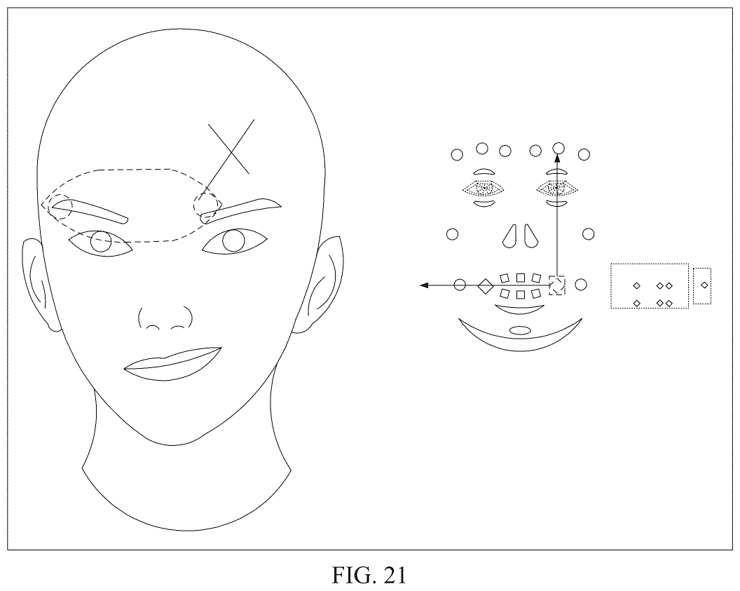

Specifically, when that the expression control changes, a position of the bone bound to the action unit associated with the expression control may change. Because the bone is bound to the vertices in the facial skin model, the movement of the bone may cause positions of the vertices of the facial skin model to change, so as to cause the expression on the virtual object face to change, thereby generating an expression conforming to the target style. Therefore, the terminal changes, in response to the adjustment operation on the expression control based on the information of the action unit associated with the expression control, the position of the bone bound to the action unit associated with the expression control, to implement the movement of the bone, and changes the positions of the vertices in the facial skin model based on the movement of the bone, to control the virtual object face to generate the expression conforming to the target style. FIG. 21 shows a face of a virtual object of a game in a specific style. A control for a mouth is controlled to drive an expression of a corner of the mouth. The expression has an intensity conforming to the design in the game style, and is neither exaggerated nor restrained.

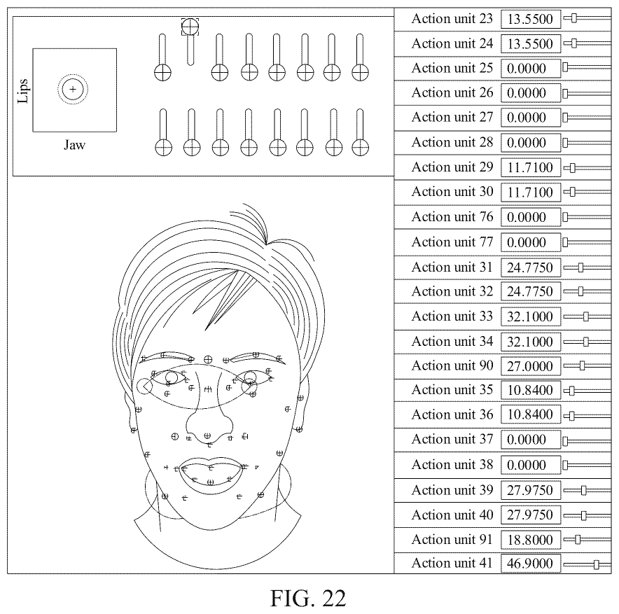

In some embodiments, the terminal may display the expression control and the information of the action unit when displaying the virtual object face. As shown in FIG. 22, when that the virtual object face is displayed, the expression controls and the information of the action units are displayed.

In the foregoing facial expression processing method, the skeletal structure of the three-dimensional facial model of the target style is determined, the style expression template matching the target style is determined, the action unit in the style expression template is bound to the one or more corresponding bones in the skeletal structure, the target expression control combination is displayed, the expression control in the target expression control combination is associated with at least one action unit in the style expression template, the skeletal structure is skinned to generate the virtual object face, and the bound bone is driven to move in response to the adjustment operation on at least one expression control based on the information of the action unit associated with the expression control, to control the virtual object face to generate the expression conforming to the target style. Therefore, for each style, the expression on the virtual object face may be quickly processed to generate an expression conforming to a corresponding style, thereby improving efficiency of facial expression processing.

In some embodiments, the determining a style expression template matching the target style, and binding an action unit in the style expression template to a one or more corresponding bones in the skeletal structure includes: displaying object types respectively corresponding to a plurality of styles, the plurality of styles including the target style; determining, when that a target object type in the target style is selected, facial skeleton information corresponding to the target object type, and determining the style expression template matching the target style; and binding the action unit in the style expression template to the one or more corresponding bones in the skeletal structure based on the facial skeleton information.

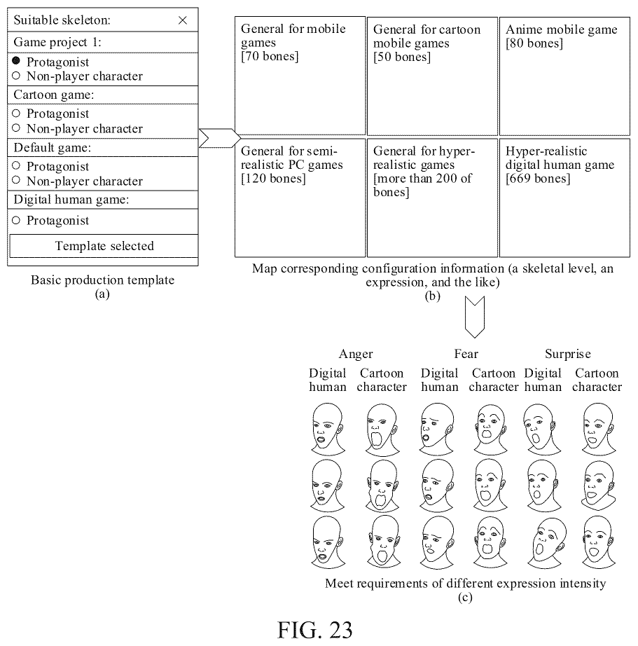

The plurality of styles indicate at least two styles, and the plurality of styles include the target style. An object type refers to a type of a virtual object. The object types may be classified based on identities of the virtual objects in a virtual scene. In an example in which the virtual scene is a game scene, the object types may be classified into a protagonist and a non-player character (NPC). Certainly, the object types may alternatively be classified in another manner, which is not limited here. Each style may correspond to at least one object type, for example, two object types may be included. In an example in which the virtual scene is a game scene and the style is a cartoon style, object types corresponding to the cartoon style may include a protagonist and an NPC. The target object type may be any object type in the target style. Section (a) in FIG. 23 shows object types respectively corresponding to a plurality of styles. In FIG. 23, “game project 1”, “cartoon game”, “default game”, and “digital human game” respectively represent games in different styles, and represent different styles. “Protagonist” and “non-player character” are object types. It can be learned that different styles respectively correspond to at least one object type.

The facial skeleton information may include at least one of a quantity of bones or a bone identifier of the virtual object face. The bone identifier may be, for example, a bone name. Section (b) in FIG. 23 shows quantities of bones of virtual object faces in the plurality of styles. Facial skeleton information of each object type is preset. In different styles, facial skeleton information corresponding to the same object type may be different or the same.

Specifically, after determining the skeletal structure of the three-dimensional facial model of the target style, the terminal displays the template determining window when that the binding operation is detected, and displays in the template determining window the object types corresponding to the plurality of styles, including the object type corresponding to the target style. When that the target object type in the target style is selected, the terminal determines, in response to the selection completion operation, the facial skeleton information corresponding to the target object type in the target style, determines the style expression template matching the target style, and binds the action unit in the style expression template to the one or more corresponding bones in the skeletal structure based on the facial skeleton information. The binding operation is configured for triggering display of the template determining window. The binding operation may be, for example, the click/tap operation on the control 308, namely, the “automatic rigging” control in FIG. 3. The template determining window is as shown in FIG. 17. When that the click/tap operation on the control 308 is detected, the terminal displays the template determining window in FIG. 17. In FIG. 17, “game project 1”, “cartoon game”, “default game”, and “digital human game” respectively represent games in different styles, and represent different styles. “Protagonist” and “non-player character” are object types. It can be learned that different styles respectively correspond to at least one object type. The selection completion operation may be, for example, the click/tap operation on the control 1702 in FIG. 17.

In some embodiments, mapping relationships between styles and style expression templates may be pre-stored on the terminal, and mapping relationships between object types in styles and facial skeleton information may also be pre-stored on the terminal. The mapping relationships between the styles and the style expression templates are generated in advance, and the mapping relationships between the object types in the styles and the facial skeleton information are also generated in advance. When that the target object type in the target style is selected, the terminal may determine, based on the mapping relationships between the styles and the style expression templates, the style expression template matching the target style, and can determine, based on the mapping relationships between the object types in the styles and the facial skeleton information, the facial skeleton information corresponding to the target object type.

In some embodiments, an associated bone corresponding to each action unit may be pre-specified in the style expression template. The associated bone of the action unit refers to a bone that is needed to implement an action of the action unit. The terminal may determine bone identifiers of facial bones of a virtual object of the target object type based on the facial skeleton information. When that the facial skeleton information includes the bone identifiers of the facial bones of the virtual object of the target object type, the terminal may extract the bone identifier from the facial skeleton information. When that the facial skeleton information includes the quantity of bones, the terminal may obtain bone identifiers corresponding to the quantity of bones. Each bone identifier corresponding to the quantity of bones is generated in advance. The bone identifier may be, for example, a bone name. The terminal may determine the bone identifiers corresponding to the quantity of bones as bone identifiers of the facial bones of the virtual object of the target object type. The terminal may determine a bone identified by the bone identifier from the skeletal structure of the target three-dimensional facial model. When that the determined bone is an associated bone of a specific action unit in the style expression template, the terminal binds the determined bone to the action unit, to bind the action unit in the style expression template to the one or more corresponding bones in the skeletal structure. After binding, the bound bone may be driven to move based on the action unit, to generate an expression conforming to a corresponding style. Information of at least one action unit in different style expression templates is different. Therefore, if the style expression templates are different, expressions generated are also different. As shown in section (c) in FIG. 23, a digital human and a cartoon character are of different styles, and accordingly, style expression templates matched with the two are also different. Therefore, there are also differences in expressions for the same emotion. In an example in which an emotion is anger, an expression of the cartoon character is more exaggerated than that of the digital human.

In this embodiment, the object types respectively corresponding to the plurality of styles are displayed, so that for each style, an expression conforming to the style can be quickly generated based on the facial expression processing method provided in this application, thereby improving efficiency of generating an expression conforming to a required style.

In some embodiments, the method further includes: displaying an information editing area of the action unit in the style expression template when displaying the virtual object face; updating information of a target action unit in response to an information editing operation triggered in an information editing area of the target action unit; and driving, based on updated information of the target action unit, a bone bound to the target action unit to move, to update an expression on the virtual object face.

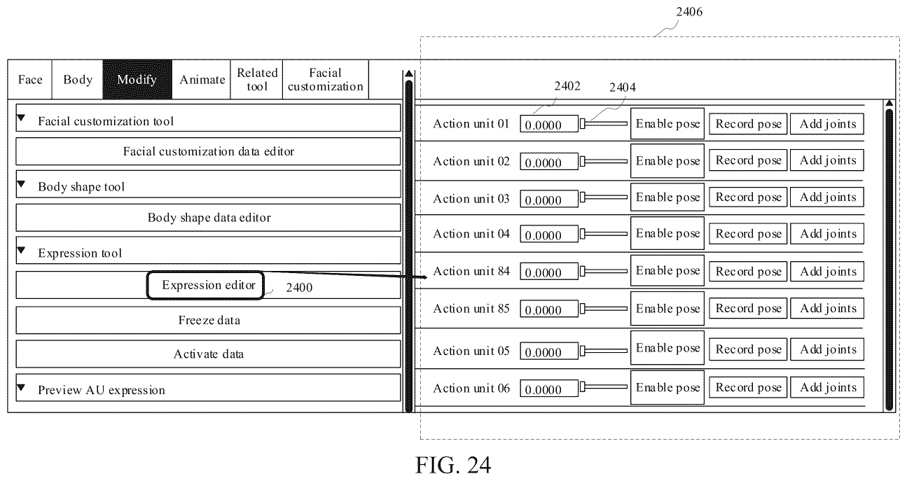

The target action unit may be any action unit in the style expression template. The information editing area of the target action unit is an area for editing the information of the target action unit, and the information editing operation is an operation of editing the information of the target action unit. The information editing area may be any area that implements information editing, including but not limited to an input box or a sliding control. The information editing operation includes, but is not limited to, inputting information into the input box or a sliding operation on the sliding control. Each action unit may have its own information editing area. As shown in FIG. 24, each action unit may have its own information editing area. A control 2402 and a control 2404 are two information editing areas of an action unit 01. The control 2402 is an input box, and the control 2404 is a sliding control.

Specifically, the terminal displays an editing area of the style expression template in response to a template editing operation, and displays the information editing area of the action unit in the editing area of the style expression template. The template editing operation may be triggered in an art tool. For example, the art tool may provide a template editing entrance. The template editing operation is a trigger operation on the template editing entrance. When displaying the template editing entrance in the art tool, the terminal displays the editing area of the style expression template in response to the trigger operation on the template editing entrance. The template editing entrance is, for example, a control 2400, namely, an “expression editor” control in FIG. 24. When that a click/tap operation on the control 2400 is detected, the terminal displays an editing area 2406 of a style expression template on the right, and displays an information editing area of an action unit in the editing area 2406, for example, displays two information editing areas of the action unit 01, that is, displays the control 2402 and the control 2404.

In some embodiments, when displaying the template editing entrance in the art tool, the terminal displays, in response to the trigger operation on the template editing entrance, the editing area of the style expression template when that the virtual object face is displayed. In other words, when displaying the virtual object face, the terminal displays the information editing area of the action unit in the style expression template. As shown in FIG. 25, a window on the left shows a virtual object face, and a window on the right shows an information editing area of an action unit.

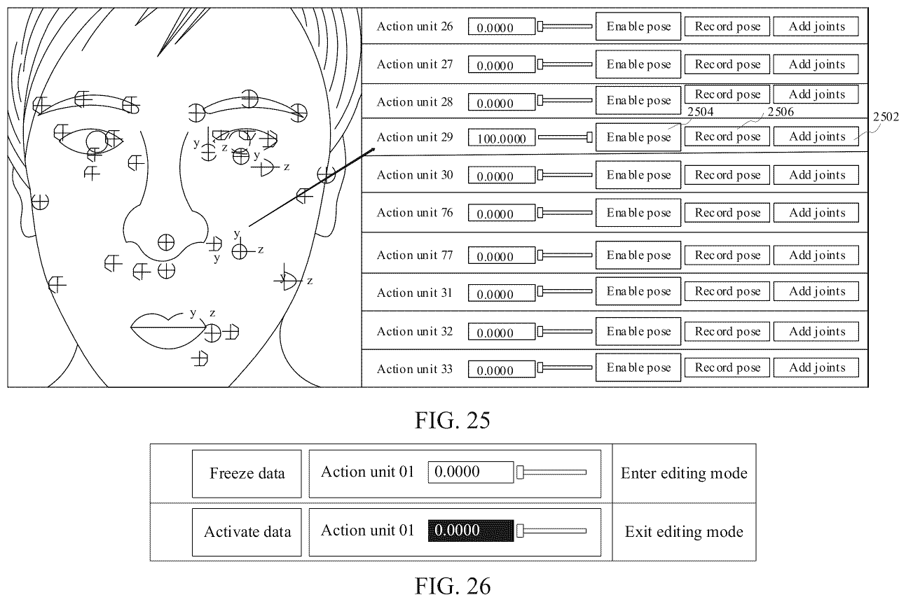

In some embodiments, the information editing area has two states: a frozen state and an activated state. When that the information editing area is in the frozen state, the terminal stops responding to an operation on the information editing area, for example, stops responding to the information editing operation. When that the information editing area is in the activated state, the terminal may respond to an operation on the information editing area, for example, respond to the information editing operation. The frozen state may also be understood as exiting an editing mode, and the activated state may also be understood as entering the editing mode. When that the target action unit is in the frozen state, the terminal may display an activation control of the target action unit. When detecting a trigger operation on the activation control, the terminal updates the activation control to a freeze control, and updates the mode of the information editing area of the target action unit to an editable mode, so that the terminal can respond to a trigger operation, such as a click/tap operation on the information editing area. When that the target action unit is in the activated state, the terminal may display a freeze control of the target action unit. When detecting a trigger operation on the freeze control, the terminal updates the freeze control to an activation control, and updates the mode of the information editing area of the target action unit to a non-editable mode, so that the terminal stops respond to a trigger operation, such as a click/tap operation on the information editing area. As shown in FIG. 26, an information editing area of an action unit 01 in the first row is in an editable mode, that is, enters an editing mode, and a “freeze data” control is a freeze control. An information editing area of the action unit 01 in the second row is in a non-editable mode, that is, exits the editing mode, and an “activate data” control is an activation control. In this embodiment, when that the information of the action unit needs to be edited, the state of the information editing area is updated from the frozen state to the activated state, so that the information editing area enters the editing mode, to provide a function of editing the information of the action unit. When that there is no need to edit the information of the action unit, the state of the information editing area is kept in the frozen state, so that the information editing area is in the non-editable mode, to prevent change of information caused by an unwanted operation on the information editing area.

In this embodiment, during displaying the virtual object face, the editing area of the action unit in the style expression template is displayed, and the expression on the virtual object face is updated based on updated information of the action unit. Therefore, when that a determined style expression template does not satisfy a requirement, the information of the action unit in the style expression template may be updated visually to optimize the style expression template, so as to optimize the expression and improve flexibility of facial expression processing, thereby improving efficiency of the facial expression processing.

In some embodiments, the method further includes: displaying a bone update area of the action unit in the style expression template; and updating, in response to a bone update operation triggered in a bone update area of the target action unit, the bone bound to the target action unit.

The bone update area may be a bone addition area or a bone removal area. The bone addition area is configured for binding at least one new bone to the action unit, and the bone removal area is configured for unbinding the action unit and one or more bound bones, where the term “more” indicates at least two. Each action unit may have its own bone update area. The bone update operation is an operation configured for adding or removing a bone bound to the action unit. For example, the bone update operation may be a click/tap operation for the bone update area.

Specifically, the terminal may display bones that are not bound to the target action unit in the skeletal structure of the target three-dimensional facial model on the virtual object face, and the terminal may display a bone, selected by a selection operation, in a selected state in response to the selection operation for the displayed bones. When that a bone addition operation triggered in a bone addition area of the target action unit is detected, the terminal may bind the bone in the selected state to the target action unit. The target action unit may be, for example, an action unit 29 in FIG. 25, and the bone addition area may be, for example, a control 2502, namely, an “add joint” control in FIG. 25. When detecting a click/tap operation on the control 2502, the terminal binds a bone in a selected state on a virtual object face that is not bound to the action unit 29 to the action unit 29. The term “add joint” may be represented as addJoints in English.

In some embodiments, the terminal may display a bone display control of the action unit in the style expression template when displaying the virtual object face. The bone display control is configured to trigger display of a bone bound to a corresponding action unit. Each action unit corresponds to a bone display control. Upon receipt of a trigger operation on a bone display control of the target action unit, the terminal can display the bone bound to the target action unit on the virtual object face. The target action unit may be, for example, the action unit 29 in FIG. 25, and the bone display control may be, for example, a control 2504, namely, an “enable pose” control in FIG. 25. The term “enable pose” may be represented as enablePose in English.

In some embodiments, the terminal may display a bone, selected by a selection operation, in a selected state in response to the selection operation on the bone bound to the displayed target action unit. When that a bone removal operation triggered in a bone removal area of the target action unit is detected, the terminal unbinds the bone in the selected state from the target action unit.

In some embodiments, the terminal may display the bone bound to the target action unit. When that a position change operation on the displayed bone is detected, the terminal updates a position of the bone, and updates the expression on the virtual object face as the position of the bone is updated. Each action unit may correspond to a pose recording control. The terminal may display a pose recording control corresponding to the target action unit. The pose recording control of the target action unit is configured to record an updated position of the bone bound to the target action unit. In an example in which the target action unit is the action unit 29 in FIG. 25, the pose recording control may be a control 2506, namely, a “record pose” control in FIG. 25. The term “record pose” may be represented as recordPose in English.

In this embodiment, the bone update area of the action unit in the style expression template is displayed, so that the bone bound to the action unit can be optimized by using the bone update area, thereby improving precise of expression control.

In some embodiments, the information editing area and the bone update area are displayed in an editing window, and the method further includes: displaying an expression template export trigger control in response to a window closing operation on the editing window; and exporting an updated expression template in response to a trigger operation on the expression template export trigger control. The updated expression template is a template obtained by updating information of at least one action unit in the style expression template or by updating the bound bone.

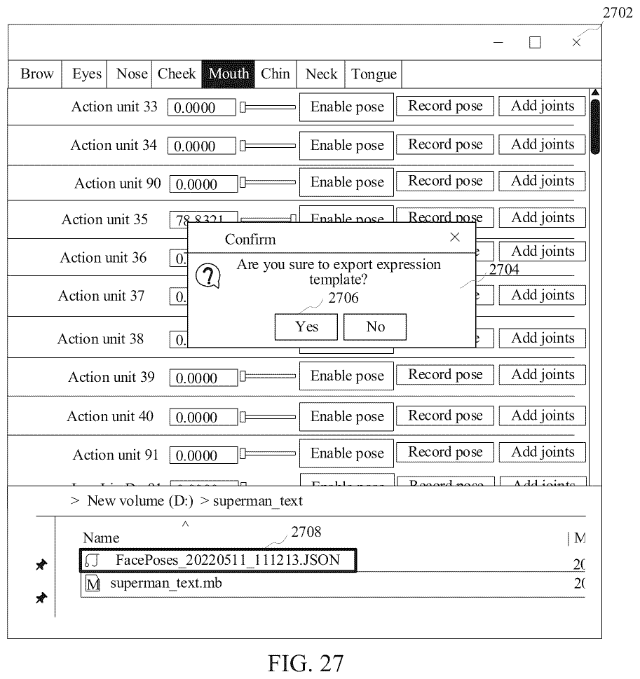

The editing window is a window provided by the art tool. The editing window refers to a window displaying the editing area of the style expression template. The window closing operation is an operation triggering closing of the editing window. The expression template export trigger control is configured to trigger export of the updated expression template. The updated expression template is a template obtained by updating the information of the action unit in the style expression template. Export refers to copying the updated expression template from art software including the art tool to outside the art software and storing the updated expression template. The export may also be understood as saving the update of the style expression template and storing the updated style expression template. The editing window may be, for example, an area for displaying an information editing area and a bone update area in FIG. 27, and the window closing operation may be, for example, a control 2702, namely, a “x” control in FIG. 27.

Specifically, after updating at least one action unit, updating the action unit includes at least one of updating the information of the action unit or updating the bound bone. The terminal displays an expression template export window after detecting the window closing operation on the editing window, and displays the expression template export trigger control in the expression template export window. The terminal generates the updated expression template after detecting the trigger operation on the expression template export trigger control, such as a click/tap operation, and displays the updated expression template. The expression template export window is, for example, a window 2704 in FIG. 27, and the expression template export trigger control is, for example, a control 2706 in the window 2704. After detecting a click/tap operation on the control 2702, the terminal displays the window 2704. After detecting a click/tap operation on the control 2706 in the window, the terminal displays an updated expression template 2708.

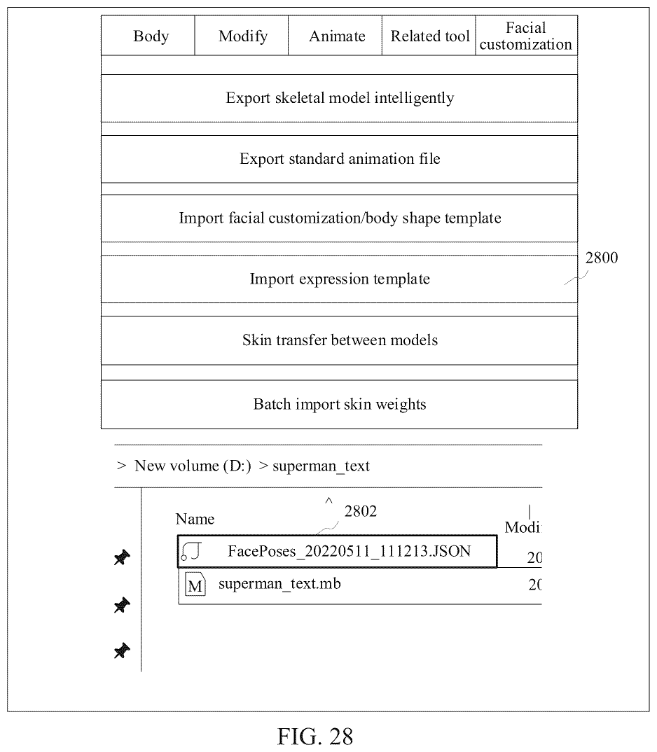

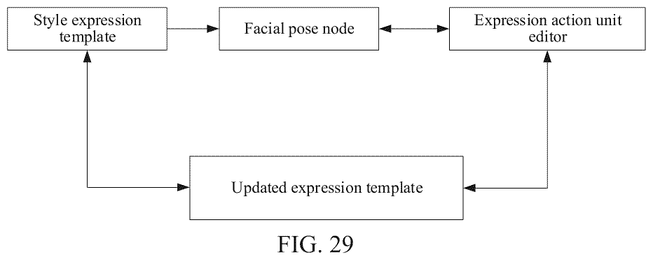

In some embodiments, the terminal may import a style expression template outside the art software into the art software, and use the imported style expression template as an expression template corresponding to a specified style. The specified style may be specified as needed. For example, in a process of controlling an expression of a protagonist in the cartoon style, a style expression template in the cartoon style is updated. An updated expression template is generated and exported, so that an updated style expression template is stored, and the updated expression template is imported as a new style expression template in the cartoon style, so that the updated expression template can be used to process expressions of another character in the cartoon style. As shown in FIG. 28, a control 2800, namely, an “import expression template” control is clicked/tapped, and then an expression template 2802 to be imported is determined, so that the expression template 2802 can be imported. As shown in FIG. 29, an “expression action unit editor” is an editor providing a function of editing the action unit. The expression action unit editor is an editor in the art tool. After obtaining the updated expression template, the expression action unit editor can be imported into the art tool as a new style expression template, and can be edited again, so that the style expression template can be continuously optimized and precise of the style expression template can be improved.

In this embodiment, the updated expression template is exported, so as to store the updated style expression template, so that the style expression template can be reused, thereby improving efficiency of facial expression processing.

In some embodiments, the three-dimensional facial model belongs to a virtual object in a target service scenario, the target expression control combination is an expression control combination matching the target service scenario, the target expression control combination includes a plurality of first expression controls, and a quantity of the plurality of first expression controls is determined based on scenario complexity of the target service scenario. The plurality of first expression controls are configured to globally adjust an expression on the virtual object face. The driving, in response to an adjustment operation on at least one expression control, the bound bone to move based on information of the action unit associated with the expression control, to control the virtual object face to generate an expression conforming to the target style includes: determining, in response to the adjustment operation on at least one expression control, an adjusted attribute value of the first expression control when that the expression control is the first expression control; and driving, based on the adjusted attribute value of the first expression control and information of an action unit associated with the first expression control, a bone bound to the associated action unit to move, to control the virtual object face to generate the expression conforming to the target style.

The three-dimensional facial model is a three-dimensional mesh model representing a face of the virtual object in the target service scenario. A service scenario includes, but is not limited to, at least one of a mobile game, a client game, or a digital human game. The complexity of different service scenarios varies. There may be a plurality of styles in a same service scenario, and accordingly, a process of determining the style expression template matching the target style may include: determining a style expression template matching a target style in the target service scenario.

The adjustment operation on the expression control is configured for changing an attribute value of the expression control. Different attribute values of the expression control result in different degrees of adjustment on the expression. A greater attribute value indicates a higher degree of adjustment on the expression. For example, when that the expression control is an emotion control of surprise, a greater attribute value of the expression control indicates a higher degree of surprise. The attribute value of the expression control changes when that the expression control is adjusted.

Specifically, when that an adjustment operation on the first expression control is detected, the terminal determines an adjusted attribute value of the first expression control, and drives, based on the adjusted attribute value of the first expression control and information of an action unit associated with the first expression control, a bone bound to the associated action unit to move, to control the virtual object face to generate the expression conforming to the target style. For example, the terminal may determine, based on the adjusted attribute value and the information of the action unit associated with the first expression control, a new position of the bone bound to the action unit associated with the first expression control, update a position of the bone to the new position, to implement movement of the bone, and control, based on the movement of the bone, vertices in a facial skin model bound to the bone to move, to implement control of the expression on the virtual object face. An example of a first expression control in FIG. 13 is used. The first expression control in an area 1302 in FIG. 13 is a movable control. Adjustment of the first expression control can be implemented by moving the first expression control. The terminal may update an expression on a virtual object face in the area 1302 in response to a moving operation on the first expression control in FIG. 13.

In this embodiment, because a quantity of the first expression controls is determined based on scenario complexity, a smaller quantity of first expression controls may be used for a simple service scenario, and a larger quantity of first expression controls may be used for a complex service scenario. In this way, processing efficiency of facial expressions in different service scenarios is improved.

In some embodiments, the target expression control combination further includes a second expression control, and the second expression control is configured to adjust details of the expression on the virtual object face. The method further includes: determining an adjusted attribute value of the second expression control when that the expression control is the second expression control; and driving, based on the adjusted attribute value of the second expression control and information of an action unit associated with the second expression control, a bone bound to the associated action unit to move, to adjust the details of the expression on the virtual object face.

Specifically, each second expression control is configured to control movement of a single bone, to control dynamic changes of facial muscles to generate an expression. When that an adjustment operation on the second expression control is detected, the terminal determines an adjusted attribute value of the second expression control, and drives, based on the adjusted attribute value of the second expression control and information of an action unit associated with the second expression control, a bone bound to the associated action unit to move, to adjust the details of the expression on the virtual object face. For example, the terminal may determine, based on the adjusted attribute value and the information of the action unit associated with the second expression control, a new position of the bone bound to the action unit associated with the second expression control, update a position of the bone to the new position, to implement movement of the bone, and control, based on the movement of the bone, vertices in a facial skin model bound to the bone to move, to implement control of the expression on the virtual object face. An example of a second expression control in an area 1306 in FIG. 13 is used. The second expression control in the area 1306 is a movable control. Adjustment of the second expression control can be implemented by moving the second expression control. The terminal can update details of an expression on a virtual object face in the area 1306 in response to a moving operation on the second expression control in the area 1306.

In this embodiment, because the second expression control is configured to adjust the details of the expression on the virtual object face, a function of adjusting the details of the expression on the virtual object face is provided, thereby improving precise of facial expression processing.

In some embodiments, the target expression control combination includes a shortcut expression control, and the shortcut expression control matches a specified expression. The driving, in response to an adjustment operation on at least one expression control, the bound bone to move based on information of the action unit associated with the expression control, to control the virtual object face to generate an expression conforming to the target style includes: obtaining an adjusted attribute value of the shortcut expression control in response to an adjustment operation on the shortcut expression control; and driving, based on the adjusted attribute value and information of an action unit associated with the shortcut expression control, a bone bound to the associated action unit to move, to control the virtual object face to generate the specified expression matching the shortcut expression control.

There may be a plurality of shortcut expression controls. The shortcut expression control matches specified expressions. One shortcut expression control is configured for calling out one specified expression. For example, when that the specified expression matching the shortcut expression control is surprise, the shortcut expression control is configured for calling out a surprised expression. The shortcut expression control includes, but is not limited to, at least one of an emotion control or a mouth shape control.

Specifically, when that an adjustment operation on the shortcut expression control is detected, the terminal determines an adjusted attribute value of the shortcut expression control, and drives, based on the adjusted attribute value of the shortcut expression control and information of an action unit associated with the shortcut expression control, a bone bound to the associated action unit to move, to control the virtual object face to generate the specified expression matching the shortcut expression control. For example, the terminal may determine, based on the adjusted attribute value and the information of the action unit associated with the shortcut expression control, a new position of the bone bound to the action unit associated with the shortcut expression control, update a position of the bone to the new position, to implement movement of the bone, and control, based on the movement of the bone, vertices in a facial skin model bound to the bone to move, to control the virtual object face to generate the specified expression matching the shortcut expression control.

In this embodiment, because the shortcut expression control matches the specified expression, the shortcut expression control may be used to control the virtual object face to generate the specified expression matching the shortcut expression control, thereby improving efficiency of generating the specified expression.

In some embodiments, the driving, based on the adjusted attribute value and information of an action unit associated with the shortcut expression control, a bone bound to the associated action unit to move, to control the virtual object face to generate the specified expression matching the shortcut expression control includes: determining, when that the shortcut expression control is an emotion control, emotion change information corresponding to the emotion control; and driving, based on the emotion change information and information of an action unit associated with the emotion control, a bone bound to the associated action unit to move, to control the virtual object face to present a specified emotion matching the emotion control.

The specified expression matching the emotion control is an expression generated by the specified emotion. The specified emotion includes, but is not limited to, at least one of smile, rage, surprise, fear, disgust, sadness, contempt, or anger.

Specifically, when that an adjustment operation on the emotion control is detected, the terminal determines an adjusted attribute value of the emotion control. The terminal determines, based on the adjusted attribute value and the information of the action unit associated with the emotion control, a new position of the bone bound to the action unit associated with the emotion control, update a position of the bone to the new position, to implement movement of the bone, and control, based on the movement of the bone, vertices in a facial skin model bound to the bone to move, to control the virtual object face to generate the expression of the specified emotion matching the emotion control. An example of an emotion control corresponding to smile in an area 1308 in FIG. 13 is used, the emotion control in the area 1308 is a sliding control. Adjustment of the emotion control can be implemented by sliding the emotion control. The terminal can control, in response to a sliding operation on the emotion control corresponding to smile in the area 1308, a virtual object face in the area 1308 to generate a smiling expression.

In this embodiment, because the emotion control is configured to generate the expression of the specified emotion, the emotion control may be used to control the virtual object face to generate the expression of the specified emotion matching the emotion control, thereby improving efficiency of generating the expression of the specified emotion.

In some embodiments, the driving, based on the adjusted attribute value and information of an action unit associated with the shortcut expression control, a bone bound to the associated action unit to move, to control the virtual object face to generate the specified expression matching the shortcut expression control includes: determining, when that the shortcut expression control is a mouth shape control, mouth shape change information corresponding to the mouth shape control; and driving, based on the mouth shape change information and information of an action unit associated with the mouth shape control, a bone bound to the associated action unit to move, to control the virtual object face to present a specified mouth shape matching the mouth shape control.

The specified expression matching the mouth shape control is an expression generated by the specified mouth shape. The specified mouth shape includes, but is not limited to, at least one of AHH, AAA, EH, or another mouth shape. The mouth shape control may alternatively be driven by audio.

Specifically, when that an adjustment operation on the mouth shape control is detected, the terminal determines an adjusted attribute value of the mouth shape control. The terminal determines, based on the adjusted attribute value and the information of the action unit associated with the mouth shape control, a new position of the bone bound to the action unit associated with the mouth shape control, update a position of the bone to the new position, to implement movement of the bone, and control, based on the movement of the bone, vertices in a facial skin model bound to the bone to move, to control the virtual object face to generate the expression of the specified mouth shape matching the mouth shape control. An example of a mouth shape control corresponding to mouth shape AAA in an area 1304 in FIG. 13 is used. The mouth shape control in the area 1304 is a sliding control. Adjustment of the mouth shape control can be implemented by sliding the mouth shape control. The terminal may control, in response to a sliding operation on the mouth shape control corresponding to mouth shape AAA in the area 1304, a virtual object face in the area 1304 to generate an expression of mouth shape AAA.

In this embodiment, because the mouth shape control is configured to generate the expression of the specified mouth shape, the mouth shape control may be used to control the virtual object face to generate the expression of the specified mouth shape matching the mouth shape control, thereby improving efficiency of generating the expression of the specified mouth shape.

In some embodiments, the three-dimensional facial model of the target style is a target three-dimensional facial model. The determining a skeletal structure of a three-dimensional facial model of a target style includes: performing affine transformation on a standard three-dimensional facial model based on the target three-dimensional facial model, to obtain a three-dimensional facial model undergone affine transformation; and determining, based on bones bound to vertices in the three-dimensional facial model undergone affine transformation, bones bound to vertices in the target three-dimensional facial model, to obtain a skeletal structure of the target three-dimensional facial model.

The affine transformation is configured for changing positions of the vertices in the standard three-dimensional facial model, so that the standard three-dimensional facial model is similar to the target three-dimensional facial model in terms of shape and position, so that a shape of the three-dimensional facial model undergone affine transformation is basically consistent with a shape of the target three-dimensional facial model. In addition, space enclosed by the three-dimensional facial model undergone affine transformation is basically the same as space enclosed by the target three-dimensional facial model, so that the three-dimensional facial model undergone affine transformation can represent a surface of a virtual object face.

Specifically, key points of the target three-dimensional facial model are referred to as target key points. There are a plurality of target key points, and the “a plurality of” indicates at least two. The target key points may be automatically generated, or may be obtained through prediction based on user-marked key points. A key point represents a position of a key part on a face. The key part includes, but is not limited to, at least one of eyebrows, eyes, a nose, a chin, or the like. When that a model matching operation is detected, the terminal may obtain the target key points of the target three-dimensional facial model, and obtain an affine transformation matrix based on coordinate transformation relationships between the target key points and the corresponding standard key points. The affine transformation matrix is configured for transforming coordinates of the standard key points to coordinates of the target key points corresponding to the standard key points, and may also be configured for transforming the coordinates of the target key points to the coordinates of the standard key points corresponding to the target key points. The model matching operation is configured for triggering the terminal to generate the three-dimensional facial model undergone affine transformation.

In some embodiments, the vertices in the target three-dimensional facial model may be referred to as target vertices, and the vertices in the three-dimensional facial model undergone affine transformation may be referred to as affine vertices. For each target vertex in the target three-dimensional facial model, the terminal may determine an affine vertex closest to the target vertex from the three-dimensional facial model undergone affine transformation, and determine a bone bound to the affine vertex as a bone bound to the target vertex. Bones bound to the target vertices form the skeletal structure of the target three-dimensional facial model.

In this embodiment, the affine transformation is performed on the standard three-dimensional facial model, so that bones bound to the vertices in the target three-dimensional facial model can be determined based on bones bound to the vertices in the three-dimensional facial model undergone affine transformation, to obtain the skeletal structure of the target three-dimensional facial model. In this way, the skeletal structure of the target three-dimensional facial model is quickly and accurately determined.

In some embodiments, the performing affine transformation on a standard three-dimensional facial model based on the target three-dimensional facial model, to obtain a three-dimensional facial model undergone affine transformation includes: obtaining target key points corresponding to the target three-dimensional facial model through prediction based on reference key points of the target three-dimensional facial model; determining coordinate transformation relationships between the target key points and corresponding standard key points, to obtain an affine transformation matrix, the standard key points being key points of the standard three-dimensional facial model; and performing affine transformation on vertex positions in the standard three-dimensional facial model by using the affine transformation matrix, to obtain the three-dimensional facial model undergone affine transformation.

The reference key point may be a key point obtained by marking. For example, the reference key point may be a key point obtained by marking a position of a mouth, a chin, or a nose. The target key point is obtained through prediction based on the reference key point. The affine transformation matrix reflects the coordinate transformation relationships between the target key points and the corresponding standard key points.

Specifically, the terminal may respond to a key point marking operation when displaying the target three-dimensional facial model. The key point marking operation is configured for marking a key point on the target three-dimensional facial model, and the key point marked by the key point marking operation may be determined as a reference key point. For example, when displaying the target three-dimensional facial model, the terminal may respond to the key point marking operation. The key point marking operation is configured for marking a key point on the target three-dimensional facial model. The terminal may determine, in response to the model matching operation, the key point marked by the key point marking operation as the reference key point, to obtain the target key points corresponding to the target three-dimensional facial model through prediction based on the reference key points of the target three-dimensional facial model. In this embodiment, the key point marked by the key point marking operation is determined as the reference key point, so that efficiency of determining the reference key point is improved.

In some embodiments, after obtaining the affine transformation matrix, the terminal may multiply coordinates of the vertices in the standard three-dimensional facial model by the affine transformation matrix. A result of the multiplication is new coordinates, and points at the new coordinates are used as vertices in the three-dimensional facial model undergone affine transformation.

In this embodiment, the affine transformation matrix is obtained based on the coordinate transformation relationships between the key points. The obtained affine transformation matrix can be used to perform affine transformation on the standard three-dimensional facial model, to obtain a three-dimensional facial model that is similar to the standard three-dimensional facial model in position and shape, so that precise of the affine transformation is improved.

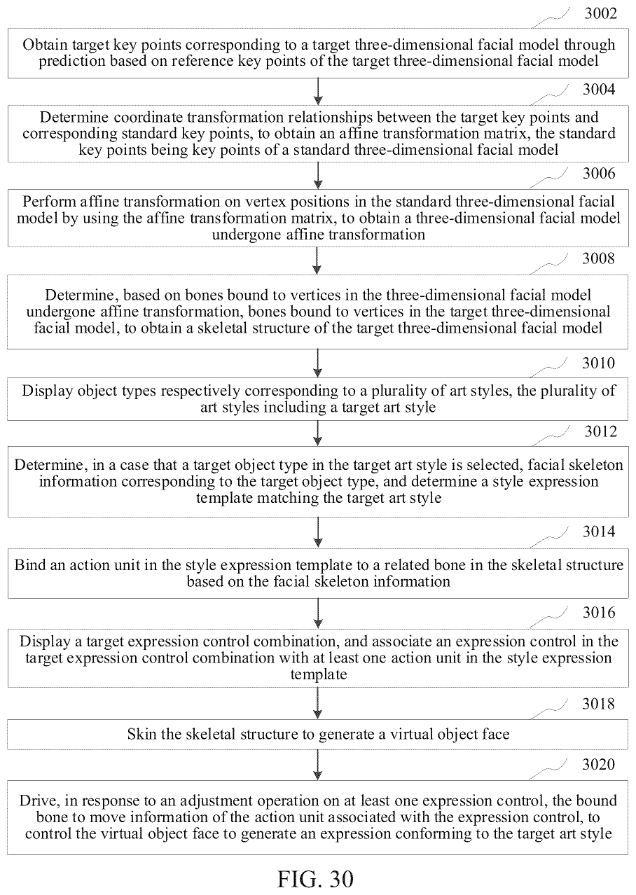

In some embodiments, as shown in FIG. 30, a facial expression processing method is provided. The method may be performed by a terminal or a server, or may be performed jointly by a terminal and a server. An example in which the method is applied to a terminal is used for description. The method includes the following operations:

Operation 3002: Obtain target key points corresponding to a target three-dimensional facial model through prediction based on reference key points of the target three-dimensional facial model.

Operation 3004: Determine coordinate transformation relationships between the target key points and corresponding standard key points, to obtain an affine transformation matrix, the standard key points being key points of a standard three-dimensional facial model.

Operation 3006: Perform affine transformation on vertex positions in the standard three-dimensional facial model by using the affine transformation matrix, to obtain a three-dimensional facial model undergone affine transformation.

Operation 3008: Determine, based on bones bound to vertices in the three-dimensional facial model undergone affine transformation, bones bound to vertices in the target three-dimensional facial model, to obtain a skeletal structure of the target three-dimensional facial model.

Operation 3010: Display object types respectively corresponding to a plurality of styles, the plurality of styles including a target style.

Operation 3012: Determine, when that a target object type in the target style is selected, facial skeleton information corresponding to the target object type, and determine a style expression template matching the target style.

Operation 3014: Bind an action unit in the style expression template to a one or more corresponding bones in the skeletal structure based on the facial skeleton information.

Operation 3016: Display a target expression control combination, and associate an expression control in the target expression control combination with at least one action unit in the style expression template.

Operation 3018: Skin the skeletal structure to generate a virtual object face.

Operation 3020: Drive, in response to an adjustment operation on at least one expression control, the bound bone to move based on information of the action unit associated with the expression control, to control the virtual object face to generate an expression conforming to the target style.

The facial expression processing method provided in this application defines precise of different styles for different projects. Each template maps different configuration information (different quantities of bones, different quantities of expression AU parameters, and the like), so that requirements of expression intensity of different styles can be met, and exclusive controller combinations are customized for templates of different precise. Therefore, according to the facial expression processing method provided in this application, expression data can be automatically generated, adapted to expression styles and technical levels of different games, and transformed into an asset file that can be controlled by an art designer, to facilitate further production of an expression animation sequence. The facial expression processing method provided in this application can meet service requirements of various mobile games, client games, consoles, and computer graphics (CG). The method has high universality. In addition, matching tools have a high degree of automation, allow for simple and flexible animation control, and can achieve natural effects without any excessively exaggerate or disharmonious presentation. This effectively helps the service achieve one-to-N mass production and greatly improves production efficiency and precise of expression data.

The facial expression processing method provided in this application may be applied to any scenario that requires facial expression processing, including but not limited to at least one of film and television special effects, visual design, a game, animation, virtual reality (VR), industrial simulation, digital cultural creation, or another scenario. The facial expression processing method provided in this application may be applied to scenario such as film and television special effects, visual design, a game, animation, virtual reality, industrial simulation, and digital cultural creation, and can improve processing efficiency of a facial expression while ensuring precise of the facial expression. For example, in a game scene, a required expression for a virtual object in the game may be generate by using the facial expression processing method provided in this application. In an animation scenario, a required expression for a virtual object in the animation may be generate by using the facial expression processing method provided in this application.

Although operations in flowcharts described in the foregoing embodiments are displayed in sequence as indicated by arrows, these operations are not necessarily performed in sequence as indicated by the arrows. Unless otherwise explicitly specified in this application, execution of the operations is not strictly limited, and the operations may be performed in other sequences. Moreover, at least part of the operations in each embodiment may include a plurality of operations or a plurality of stages. The operations or stages are not necessarily performed at the same moment but may be performed at different moments. Execution of the operations or stages is not necessarily performed in sequence, but may be performed alternately with other operations or at least part of operations or stages of other operations.

Based on the same inventive concept, an embodiment of this application further provides a facial expression processing apparatus for implementing the foregoing facial expression processing method. An implementation for resolving problems provided by the apparatus is similar to the implementation described in the foregoing method. Therefore, for the specific limitations in one or more facial expression processing apparatus embodiments provided below, refer to the foregoing limitations on the facial expression processing method. Details are not described herein again.

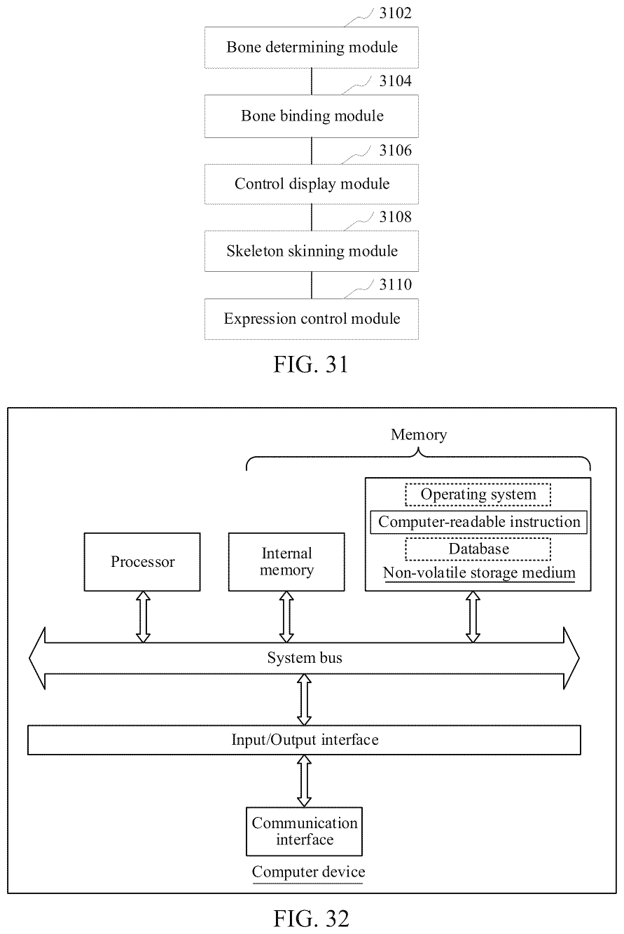

In some embodiments, as shown in FIG. 31, a facial expression processing apparatus is provided, the apparatus including: a bone determining module 3102, a bone binding module 3104, a control display module 3106, a skeleton skinning module 3108, and an expression control module 3110.

The bone determining module 3102 is configured to determine a skeletal structure of a three-dimensional facial model of a target style.

The bone binding module 3104 is configured to determine a style expression template matching the target style, and bind an action unit in the style expression template to a one or more corresponding bones in the skeletal structure.

The control display module 3106 is configured to display a target expression control combination, and associate an expression control in the target expression control combination with at least one action unit in the style expression template.

The skeleton skinning module 3108 is configured to skin the skeletal structure to generate a virtual object face.

The expression control module 3110 is configured to drive, in response to an adjustment operation on at least one expression control, the bound bone to move based on information of the action unit associated with the expression control, to control the virtual object face to generate an expression conforming to the target style.

In some embodiments, the bone binding module is further configured to: display object types respectively corresponding to a plurality of styles, the plurality of styles including the target style; determine, when that a target object type in the target style is selected, facial skeleton information corresponding to the target object type, and determine the style expression template matching the target style; and bind the action unit in the style expression template to the one or more corresponding bones in the skeletal structure based on the facial skeleton information.

In some embodiments, the apparatus further includes an action unit update module. The action unit update module is configured to: display an information editing area of the action unit in the style expression template when displaying the virtual object face; update information of a target action unit in response to an information editing operation triggered in an information editing area of the target action unit; and drive, based on updated information of the target action unit, a bone bound to the target action unit to move, to update an expression on the virtual object face.

In some embodiments, the action unit update module is further configured to: display a bone update area of the action unit in the style expression template; and update, in response to a bone update operation triggered in a bone update area of the target action unit, the bone bound to the target action unit.

In some embodiments, the information editing area and the bone update area are displayed in an editing window, and the apparatus further includes a template export module. The template export module is configured to: display an expression template export trigger control in response to a window closing operation on the editing window; and export an updated expression template in response to a trigger operation on the expression template export trigger control. The updated expression template is a template obtained by updating information of at least one action unit in the style expression template or by updating the bound bone.

In some embodiments, the information editing area has two states: a frozen state and an activated state. The apparatus is further configured to: stop responding to an operation on the information editing area when that the information editing area is in the frozen state; or respond to an operation on the information editing area when that the information editing area is in the activated state.

In some embodiments, the three-dimensional facial model belongs to a virtual object in a target service scenario, the target expression control combination is an expression control combination matching the target service scenario, the target expression control combination includes a plurality of first expression controls, and a quantity of the plurality of first expression controls is determined based on scenario complexity of the target service scenario. The plurality of first expression controls are configured to globally adjust an expression on the virtual object face. The expression control module is further configured to: determine, in response to the adjustment operation on at least one expression control, an adjusted attribute value of the first expression control when that the expression control is the first expression control; and drive, based on the adjusted attribute value of the first expression control and information of an action unit associated with the first expression control, a bone bound to the associated action unit to move, to control the virtual object face to generate the expression conforming to the target style.

In some embodiments, the target expression control combination further includes a second expression control, and the second expression control is configured to adjust details of the expression on the virtual object face. The expression control module is further configured to: determine an adjusted attribute value of the second expression control when that the expression control is the second expression control; and drive, based on the adjusted attribute value of the second expression control and information of an action unit associated with the second expression control, a bone bound to the associated action unit to move, to adjust the details of the expression on the virtual object face.

In some embodiments, the target expression control combination includes a shortcut expression control, and the shortcut expression control matches a specified expression. The expression control module is further configured to: obtain an adjusted attribute value of the shortcut expression control in response to an adjustment operation on the shortcut expression control; and drive, based on the adjusted attribute value and information of an action unit associated with the shortcut expression control, a bone bound to the associated action unit to move, to control the virtual object face to generate the specified expression matching the shortcut expression control.

In some embodiments, the expression control module is further configured to: determine, when that the shortcut expression control is an emotion control, an adjusted attribute value corresponding to the emotion control; and drive, based on the adjusted attribute value and information of an action unit associated with the emotion control, a bone bound to the associated action unit to move, to control the virtual object face to present a specified emotion matching the emotion control.

In some embodiments, the expression control module is further configured to: determine, when that the shortcut expression control is a mouth shape control, mouth shape change information corresponding to the mouth shape control; and drive, based on the mouth shape change information and information of an action unit associated with the mouth shape control, a bone bound to the associated action unit to move, to control the virtual object face to present a specified mouth shape matching the mouth shape control.

In some embodiments, the three-dimensional facial model of the target style is a target three-dimensional facial model. The bone determining module is further configured to: perform affine transformation on a standard three-dimensional facial model based on the target three-dimensional facial model, to obtain a three-dimensional facial model undergone affine transformation; and determine, based on bones bound to vertices in the three-dimensional facial model undergone affine transformation, bones bound to vertices in the target three-dimensional facial model, to obtain a skeletal structure of the target three-dimensional facial model.

In some embodiments, the bone determining module is further configured to: obtain target key points corresponding to the target three-dimensional facial model through prediction based on reference key points of the target three-dimensional facial model; determine coordinate transformation relationships between the target key points and corresponding standard key points, to obtain an affine transformation matrix, the standard key points being key points of the standard three-dimensional facial model; and perform affine transformation on vertex positions in the standard three-dimensional facial model by using the affine transformation matrix, to obtain the three-dimensional facial model undergone affine transformation.

In some embodiments, the apparatus is further configured to: respond to a key point marking operation when displaying the target three-dimensional facial model, the key point marking operation being configured for marking a key point on the target three-dimensional facial model; and determine the key point marked by the key point marking operation as a reference key point.

All or part of the modules in the foregoing facial expression processing apparatus may be implemented through software, hardware, or a combination thereof. The foregoing modules may be embedded in hardware form or independent of a processor in a computer device, or may be stored in software form in a memory in the computer device, so that the processor may be called to perform operations corresponding to the foregoing modules.

In some embodiments, a computer device is provided. The computer device may be a server, and an internal structure of the computer device may be as shown in FIG. 32. The computer device includes a processor, a memory, an input/output interface (I/O), and a communication interface. The processor, the memory, and the input/output interface are connected via a system bus, and the communication interface is connected to the system bus via the input/output interface. The processor of the computer device is configured to provide computing and control capabilities. The memory of the computer device includes a non-transitory storage medium and an internal memory. The non-transitory storage medium has an operating system, computer-readable instructions, and a database stored thereon. The internal memory provides a running environment for the operating system and the computer-readable instructions on the non-transitory storage medium. The database of the computer device is configured to store data in the facial expression processing method. The input/output interface of the computer device is configured for information exchange between the processor and an external device. The communication interface of the computer device is configured to be connected to and communicate with an external terminal over a network. The computer-readable instructions, when executed by the processor, implement a facial expression processing method.

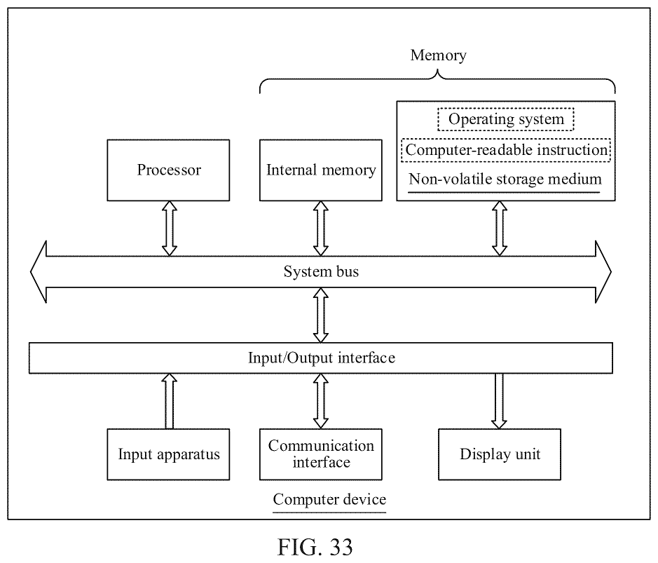

In some embodiments, a computer device is provided. The computer device may be a terminal, and an internal structure of the computer device may be as shown in FIG. 33. The computer device includes a processor, a memory, an input/output interface, a communication interface, a display unit, and an input apparatus. The processor, the memory, and the input/output interface are connected via a system bus, and the communication interface, the display unit, and the input apparatus are connected to the system bus via the input/output interface. The processor of the computer device is configured to provide computing and control capabilities. The memory of the computer device includes a non-transitory storage medium and an internal memory. The non-transitory storage medium has an operating system and computer-readable instructions stored thereon. The internal memory provides a running environment for the operating system and the computer-readable instructions on the non-transitory storage medium. The input/output interface of the computer device is configured for information exchange between the processor and an external device. The communication interface of the computer device is configured to communicate with an external terminal in a wire or wireless manner. The wireless manner may be implemented by using Wi-Fi, a mobile cellular network, near field communication (NFC), or another technology. The computer-readable instructions, when executed by the processor, implement a facial expression processing method. The display unit of the computer device is configured to form a visually visible picture, and may be a display screen, a projection apparatus, or a virtual reality imaging apparatus. The display screen may be a liquid crystal display or an e-ink display screen. The input apparatus of the computer device may be a touch layer covering the display screen, may be a button, a trackball, or a touchpad disposed on a housing of the computer device, or may be an external keyboard, a touchpad, a mouse, or the like.

A person skilled in the art may understand that the structures shown in FIG. 32 and FIG. 33 are merely block diagrams of partial structures related to a solution in this application, and do not constitute a limitation to the computer device to which the solution in this application is applied. Specifically, the computer device may include more or fewer components than those shown in the figure, or have some components combined, or have a different component arrangement.

In some embodiments, a computer device is provided. The computer device including a memory and one or more processors. The memory has computer-readable instructions stored therein. The computer-readable instructions, when executed by the processor, cause the one or more processors to implement operations of the foregoing facial expression processing method.

In some embodiments, one or more non-transitory computer readable storage media are provided. The non-transitory computer readable storage medium has computer-readable instructions stored thereon. The computer-readable instructions, when executed by one or more processors, cause the one or more processors to implement operations of the foregoing facial expression processing method.

In some embodiments, a computer program product is provided. The computer program includes computer-readable instructions. The computer-readable instructions, when executed by a processor, implement operations of the foregoing facial expression processing method.

User information (including but not limited to user device information, user personal information, and the like) and data (including but not limited to data used for analysis, stored data, displayed data, and the like), included in this application are information and data that all authorized by a user or fully authorized by all parties. Collection, use, and processing of related data need to comply with relevant laws, regulations, and standards of relevant countries and regions.

A person of ordinary skill in the art may understand that all or some of procedures of the method in the foregoing embodiments may be implemented by instructing relevant hardware by using computer-readable instructions. The computer-readable instructions may be stored in a non-transitory computer-readable storage medium. When the computer-readable instructions are executed, the processes of the embodiments of the methods may be included. Any reference to the memory, database, or another medium used in embodiments provided in this application may include at least one of a non-transitory and a volatile memory. The non-transitory memory may include a read-only memory (ROM), a magnetic tape, a floppy disk, a flash memory, an optical memory, a high-density embedded non-transitory memory, a resistive memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, or the like. As an illustration but not a limitation, the RAM may be in various forms, such as a static random access memory (SRAM) or a dynamic random access memory (DRAM). The databases in embodiments provided in this application may include at least one of a relational database and a non-relational database. The non-relational database may include a blockchain-based distributed database, and the like. This is not limited herein. The processor in the embodiments provided in this application may be a general-purpose processor, a central processing unit, a graphics processor, a digital signal processor, a programmable logic device, a data processing logic device based on quantum computing, and the like. This is not limited herein.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments merely show several implementations of this application. The descriptions thereof are relatively specific and detailed, but shall not be understood as limitations to the scope of this application. For a person of ordinary skill in the art, several transformations and improvements may be made without departing from the idea of this application. These transformations and improvements fall within the protection scope of this application. Therefore, the protection scope of this application shall be subject to the appended claims.

What is claimed is:

1. A facial expression processing method performed by a computer device, the method comprising:
determining a skeletal structure of a three-dimensional facial model of a target style;
skinning the skeletal structure to generate a virtual object face;
binding an action unit in a style expression template matching the target style to a one or more corresponding bones in the skeletal structure;
associating at least one expression control with at least one action unit in the style expression template;
in response to an adjustment operation on the at least one expression control, driving bones bound to the at least one action unit to move based on information of the at least one action unit associated with the expression control; and
controlling the virtual object face to generate an expression conforming to the target style in accordance with the movement of the bones triggered by the adjustment operation.

2. The method according to claim 1, wherein the binding an action unit in a style expression template matching the target style to a one or more corresponding bones in the skeletal structure comprises:
displaying object types corresponding to a plurality of styles;
when that a target object type in the target style is selected, determining facial skeleton information corresponding to the target object type and the style expression template matching the target style; and
binding the action unit in the style expression template to the one or more corresponding bones in the skeletal structure based on the facial skeleton information.

3. The method according to claim 1, further comprising:
displaying an information editing area of the at least one action unit in the style expression template when the virtual object face is displayed;
updating information of a target action unit in response to an information editing operation triggered in an information editing area of the target action unit; and
based on updated information of the target action unit, driving a bone bound to the target action unit to move to update an expression on the virtual object face.

4. The method according to claim 3, further comprising:
displaying a bone update area of the action unit in the style expression template; and
in response to a bone update operation triggered in a bone update area of the target action unit, updating the bone bound to the target action unit.

5. The method according to claim 3, wherein the information editing area has two states: a frozen state and an activated state; and the method further comprises:
stopping responding to an operation on the information editing area when that the information editing area is in the frozen state; or
responding to an operation on the information editing area when that the information editing area is in the activated state.

6. The method according to claim 1, wherein the at least one expression control comprises a shortcut expression control that matches a specified expression; and the method further comprises:
obtaining an adjusted attribute value of the shortcut expression control in response to an adjustment operation on the shortcut expression control; and
driving, based on the adjusted attribute value and information of an action unit associated with the shortcut expression control, a bone bound to the associated action unit to move; and
controlling the virtual object face to generate the specified expression matching the shortcut expression control.

7. The method according to claim 1, wherein the three-dimensional facial model of the target style is a target three-dimensional facial model; and the determining a skeletal structure of a three-dimensional facial model of a target style comprises:
performing affine transformation on a standard three-dimensional facial model based on the target three-dimensional facial model, to obtain a three-dimensional facial model undergone affine transformation; and
determining, based on bones bound to vertices in the three-dimensional facial model undergone affine transformation, bones bound to vertices in the target three-dimensional facial model, to obtain a skeletal structure of the target three-dimensional facial model.

8. A computer device, comprising a memory and one or more processors, the memory having computer-readable instructions stored therein, and the computer-readable instructions, when executed by the one or more processors, causing the computer device to perform a facial expression processing method including:
determining a skeletal structure of a three-dimensional facial model of a target style;
skinning the skeletal structure to generate a virtual object face;
binding an action unit in a style expression template matching the target style to a one or more corresponding bones in the skeletal structure;
associating at least one expression control with at least one action unit in the style expression template;
in response to an adjustment operation on the at least one expression control, driving bones bound to the at least one action unit to move based on information of the at least one action unit associated with the expression control; and
controlling the virtual object face to generate an expression conforming to the target style in accordance with the movement of the bones triggered by the adjustment operation.

9. The computer device according to claim 8, wherein the binding an action unit in a style expression template matching the target style to a one or more corresponding bones in the skeletal structure comprises:
displaying object types corresponding to a plurality of styles;
when that a target object type in the target style is selected, determining facial skeleton information corresponding to the target object type and the style expression template matching the target style; and
binding the action unit in the style expression template to the one or more corresponding bones in the skeletal structure based on the facial skeleton information.

10. The computer device according to claim 8, wherein the method further comprises:
displaying an information editing area of the at least one action unit in the style expression template when the virtual object face is displayed;
updating information of a target action unit in response to an information editing operation triggered in an information editing area of the target action unit; and
based on updated information of the target action unit, driving a bone bound to the target action unit to move to update an expression on the virtual object face.

11. The computer device according to claim 10, wherein the method further comprises:
displaying a bone update area of the action unit in the style expression template; and
in response to a bone update operation triggered in a bone update area of the target action unit, updating the bone bound to the target action unit.

12. The computer device according to claim 10, wherein the information editing area has two states: a frozen state and an activated state; and the method further comprises:
stopping responding to an operation on the information editing area when that the information editing area is in the frozen state; or
responding to an operation on the information editing area when that the information editing area is in the activated state.

13. The computer device according to claim 8, wherein the at least one expression control comprises a shortcut expression control that matches a specified expression; and the method further comprises:
obtaining an adjusted attribute value of the shortcut expression control in response to an adjustment operation on the shortcut expression control; and
driving, based on the adjusted attribute value and information of an action unit associated with the shortcut expression control, a bone bound to the associated action unit to move; and
controlling the virtual object face to generate the specified expression matching the shortcut expression control.

14. The computer device according to claim 8, wherein the three-dimensional facial model of the target style is a target three-dimensional facial model; and the determining a skeletal structure of a three-dimensional facial model of a target style comprises:
performing affine transformation on a standard three-dimensional facial model based on the target three-dimensional facial model, to obtain a three-dimensional facial model undergone affine transformation; and
determining, based on bones bound to vertices in the three-dimensional facial model undergone affine transformation, bones bound to vertices in the target three-dimensional facial model, to obtain a skeletal structure of the target three-dimensional facial model.

15. One or more non-transitory computer-readable storage media, having computer-readable instructions stored thereon, the computer-readable instructions, when executed by one or more processors of a computer device, causing the computer device to perform a facial expression processing method including:
determining a skeletal structure of a three-dimensional facial model of a target style;
skinning the skeletal structure to generate a virtual object face;
binding an action unit in a style expression template matching the target style to a one or more corresponding bones in the skeletal structure;
associating at least one expression control with at least one action unit in the style expression template;
in response to an adjustment operation on the at least one expression control, driving bones bound to the at least one action unit to move based on information of the at least one action unit associated with the expression control; and
controlling the virtual object face to generate an expression conforming to the target style in accordance with the movement of the bones triggered by the adjustment operation.

16. The non-transitory computer-readable storage media according to claim 15, wherein the binding an action unit in a style expression template matching the target style to a one or more corresponding bones in the skeletal structure comprises:
displaying object types corresponding to a plurality of styles;
when that a target object type in the target style is selected, determining facial skeleton information corresponding to the target object type and the style expression template matching the target style; and
binding the action unit in the style expression template to the one or more corresponding bones in the skeletal structure based on the facial skeleton information.

17. The non-transitory computer-readable storage media according to claim 15, wherein the method further comprises:
displaying an information editing area of the at least one action unit in the style expression template when the virtual object face is displayed;
updating information of a target action unit in response to an information editing operation triggered in an information editing area of the target action unit; and
based on updated information of the target action unit, driving a bone bound to the target action unit to move to update an expression on the virtual object face.

18. The non-transitory computer-readable storage media according to claim 17, wherein the method further comprises:
displaying a bone update area of the action unit in the style expression template; and
in response to a bone update operation triggered in a bone update area of the target action unit, updating the bone bound to the target action unit.

19. The non-transitory computer-readable storage media according to claim 15, wherein the information editing area has two states: a frozen state and an activated state; and the method further comprises:
stopping responding to an operation on the information editing area when that the information editing area is in the frozen state; or
responding to an operation on the information editing area when that the information editing area is in the activated state.

20. The non-transitory computer-readable storage media according to claim 15, wherein the at least one expression control comprises a shortcut expression control that matches a specified expression; and the method further comprises:
obtaining an adjusted attribute value of the shortcut expression control in response to an adjustment operation on the shortcut expression control; and
driving, based on the adjusted attribute value and information of an action unit associated with the shortcut expression control, a bone bound to the associated action unit to move; and
controlling the virtual object face to generate the specified expression matching the shortcut expression control.
